(19) United States
(12) Patent Application Publication
(10) Pub. No.: US 2024/0013012 A1
(43) Pub. Date: Jan. 11, 2024

(54) INFORMATION PROCESSING SYSTEM AND INFORMATION PROCESSING APPARATUS

(71) Applicant: Canon Kabushiki Kaisha, Tokyo (JP)

(72) Inventor: TOMOYA UEHARA, Shizuoka (JP)

(21) Appl. No.: 18/473,446

(22) Filed: Sep. 25, 2023

Related U.S. Application Data
(63) Continuation of application No. PCT/JP2022/010332, filed on Mar. 9, 2022.

(30) Foreign Application Priority Data
Apr. 8, 2021 (JP) 2021-066069

(51) Int. Cl. G06K 7/10

(52) U.S. Cl. CPC G06K 7/10297

(57) ABSTRACT

An information processing system includes wireless devices arranged in a real space, a reading apparatus that includes a reading unit to read identification information from each wireless device and a measuring unit to measure an amount of movement in the real space, and a management unit that manages a database in which a position at which each wireless device should be arranged is registered. The reading apparatus provides the management unit with the read identification information and movement amount information indicating the amount of movement measured at the time of the reading. The management unit determines, for two or more wireless devices arranged in the real space, whether a first positional relationship among those wireless devices estimated based on the identification information and the movement amount information matches a second positional relationship among corresponding registered positions stored in the database.

### CROSS-REFERENCE TO RELATED APPLICATIONS

This application is a Continuation of International Patent Application No. PCT/JP2022/010332, filed Mar. 9, 2022, which claims the benefit of Japanese Patent Application No. 2021-066069, filed Apr. 8, 2021, both of which are hereby incorporated by reference herein in their entirety.

### BACKGROUND OF THE INVENTION

### Field of the Invention

The present disclosure relates to an information processing system and an information processing apparatus.

### Background Art

Radio frequency identification (RFID) is a technology that allows information embedded in a small device which is also referred to as a tag to be read by an external reader through short-range wireless communication. Among others, a passive type RFID tag, which transmits information utilizing energy of electromagnetic wave emitted from a reader, does not require a battery and thus is low-cost in manufacturing, and can operate semi-permanently. Hence, it has become widely-used in various scenes. For example, RFID tags in which unique identification information is embedded are installed at multiple points in a real space and position data of those points is pre-registered in a database so that it is possible to easily measure a position of a reader based on a result of reading identification information from the RFID tags.

Patent Literature 1 discloses a technology which measures a geographical position by a GPS function of a tag reader when a user installed a tag and issues an alert to the user depending on an error of the installation position of the tag with respect to the position registered in advance in order for the tag to be correctly installed at an intended point in a real space.

### CITATION LIST

### Patent Literature

PTL 1: Japanese Patent Laid-Open No. 2008-40837

However, the technology disclosed by Patent Literature 1 would not work effectively in a situation in which a tag is installed in a place where electric waves for GPS are not reachable or the electric waves become unstable such as inside of a building or underground. In addition, there has been a difficulty that the necessity to implement a GPS function in a tag reader increases cost and size of apparatuses.

In light of the foregoing, the present invention aims at realizing a mechanism that can detect a misalignment between a position indicated by registration information in a system and an actual arrangement of a device in a real space.

### SUMMARY OF THE INVENTION

According to an aspect, there is provided an information processing system including: a plurality of wireless devices arranged in a real space; a reading apparatus that includes a reading unit configured to read identification information stored in each wireless device and a measuring unit configured to measure a relative amount of movement in the real space; and a management unit configured to manage a database in which a position in the real space at which each wireless device should be arranged is registered in association with identification information of the wireless device, wherein the reading apparatus is configured to provide the management unit with the identification information read by the reading unit and movement amount information indicating the amount of movement measured by the measuring unit at the time of the reading, and the management unit is configured to determine, for two or more wireless devices arranged in the real space, whether a first positional relationship among the two or more wireless devices estimated based on the identification information and the movement amount information matches a second positional relationship among corresponding registered positions stored in the database. A corresponding information processing apparatus is also provided.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the present disclosure and, together with the description, serve to explain principles of the present disclosure.

FIG. 1 is a schematic view illustrating an example of a configuration of an information processing system according to a first embodiment.

FIG. 2 is a block diagram illustrating an example of a configuration of a tag reader according to the first embodiment.

FIG. 3 is a block diagram illustrating an example of a configuration of a management server according to the first embodiment.

FIG. 4A is an explanatory diagram illustrating an example of a configuration of a floor table according to the first embodiment.

FIG. 4B is an explanatory diagram illustrating an example of a configuration of a map table according to the first embodiment.

FIG. 4C is an explanatory diagram illustrating an example of a configuration of a position table according the first embodiment.

FIG. 4D is an explanatory diagram illustrating an example of a configuration of an item table according to the first embodiment.

FIG. 5A is an explanatory diagram illustrating an example of a configuration of a reading result table according to the first embodiment.

FIG. 5B is an explanatory diagram illustrating an example of a configuration of a tag detection table according to the first embodiment.

FIG. 6 is an explanatory diagram illustrating an example of a configuration of a position registration screen.

FIG. 7A is a first explanatory diagram for explaining reading of tag IDs from position tags arranged in a real space.

FIG. 7B is a second explanatory diagram for explaining reading of tag IDs from position tags arranged in a real space.

FIG. 8A is a first explanatory diagram for explaining comparison between two positional relationships in the first embodiment.

FIG. 8B is a second explanatory diagram for explaining comparison between two positional relationships in the first embodiment.

FIG. 9 is a flowchart illustrating an example of a flow of a position registration process according to the first embodiment.

FIG. 10 is a flowchart illustrating an example of a flow of position verification process according to the first embodiment.

FIG. 11 is a flowchart illustrating an example of a concrete flow of a position comparison process according to the first embodiment.

FIG. 12A is a first part of a flowchart illustrating an example of a concrete flow of a correction assistance process according to the first embodiment.

FIG. 12B is a second part of a flowchart illustrating an example of a concrete flow of the correction assistance process according to the first embodiment.

FIG. 13 is a flowchart illustrating an example of a concrete flow of a correction assistance process according to a first alteration example of the first embodiment.

FIG. 14 is a flowchart illustrating an example of a concrete flow of an automatic correction process according to a second alteration example of the first embodiment.

FIG. 15 is a schematic view illustrating an example of a configuration of an information processing system according to a second embodiment.

FIG. 16 is a block diagram illustrating an example of a configuration of a management server according to the second embodiment.

FIG. 17A is an explanatory diagram illustrating an example of a configuration of a section table according to the second embodiment.

FIG. 17B is an explanatory diagram illustrating an example of a configuration of an item table according to the second embodiment.

FIG. 17C is an explanatory diagram illustrating an example of a configuration of a reservation table according to the second embodiment.

FIG. 18A is a first explanatory diagram for explaining comparison between two positional relationships in the second embodiment.

FIG. 18B is a second explanatory diagram for explaining comparison between two positional relationships in the second embodiment.

FIG. 19 is a flowchart illustrating an example of a flow of position verification process according to the second embodiment.

FIG. 20 is a flowchart illustrating an example of a flow of schematic process according to an alteration example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### 1. First Embodiment

### 1-1. System Overview

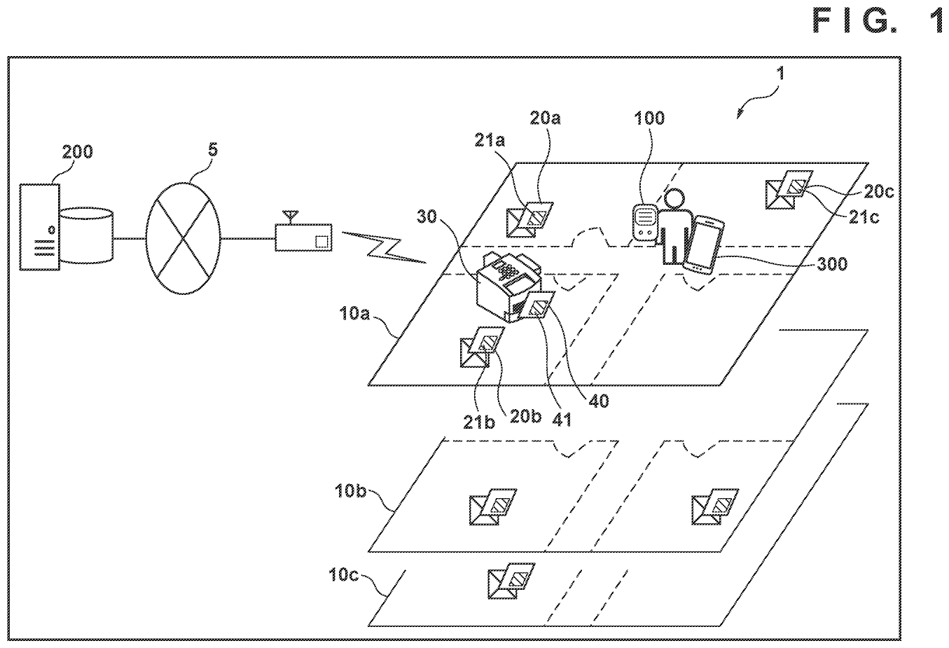

FIG. 1 is a schematic view illustrating an example of a configuration of an information processing system 1 according to a first embodiment. The information processing system 1 is a system that allows for determining a position of a target that exists in a real space based on a result of reading identification information from RFID tags arranged in a distributed manner at a plurality of positions. The target of position determination may be, for example, an RFID tag itself, an item to which an RFID tag is attached, a tag reader that reads identification information, a user that carries a tag reader, or a machine on which a tag reader is mounted. In the present specification, an RFID tag that is arranged at a specific position of the real space is referred to as a position tag, and an RFID tag that is attached to an item and moves together with the item is referred to as an item tag.

In FIG. 1, a plurality of position tags are arranged on three floors 10a, 10b and 10c of a building. For example, position tags 20a, 20b and 20c are arranged on the floor 10a. The position tags 20a, 20b and 20c have specific tag identification information 21a, 21b and 21c embedded in the tags, respectively. Note that, in the following descriptions, the position tags 20a, 20b, . . . are collectively referred to as position tags 20 by omitting the trailing alphabets from the reference signs when they do not need to be distinguished from each other. The same applies to the floors 10a, 10b, . . . (floors 10) and the identification information 21a, 21b, . . . (identification information 21) as well as any other constituent elements.

The floors 10 are parts of a building that may exist in a real space and an example of a place for which the technology according to the present disclosure can be utilized. As electric waves from GPS satellites do not easily reach inside of a building or underground, it is difficult to make use of GPS-based technologies in such places. In contrast, the technology according to the present disclosure is suitable for use in places that the electric waves are not easily reachable since it does not rely on the electric waves from satellites. However, the technology according to the present disclosure may be utilized in any place in a real space including outdoors, and can bring advantages such as cost reduction or miniaturization as it does not require implementation of a GPS function even if it is utilized outside. In addition, there may also be provided a system or an apparatus which combines the technology according to the present disclosure complementarily with a GPS-based technology.

There exists an item 30 on the floor 10a. An item tag 40 is attached to the item 30. The item tag 40 has specific tag identification information 41 embedded in the tag. Though only one item 30 that exists on the floor 10a is illustrated in FIG. 1, there may be more items 30 in practice. Each of such items 30 may be a non-living object (for example, a machine, equipment, a tool, material, a consumable good, a vehicle, or a robot) or a living object (for example, an animal or a plant). Each item 30 moves by being conveyed by a user, or moves in accordance with a user operation or autonomously (for example, it runs, walks, flies, or sails). When each item 30 moves, the item tag 40 attached to the item 30 moves together with the item 30.

In the present embodiment, each of the tags such as the position tags 20 and the item tags 40 is a kind of a wireless device and is assumed to be, in particular, a passive-type RFID tag (a passive tag). A passive tag is composed of: a small integrated circuit (IC) chip with an embedded memory; and an antenna, and has identification information for identifying the tag and some other information stored in the memory. In this specification, identification information is simply referred to as an ID, and identification information for identifying a tag is referred to as a tag ID. It should be noted that the tag ID may be considered as information for identifying an object to which the tag is attached. The IC chip of a passive tag operates by utilizing energy of an electromagnetic wave emitted from a tag reader, and modulates the information stored in the memory into an information signal to transmit (send back) the information signal from the antenna.

It should be noted that, in another embodiment, each tag may be an active-type RFID tag. If each tag actively (for example, periodically) transmits information to its vicinity by utilizing power from a built-in battery, such a tag may be called a beacon tag. In a further embodiment, each tag may be a wireless device which sends back information in response to a signal from a reader in accordance with Near Field Communication (NFC) protocol or Bluetooth (registered trademark) protocol, for example. Each tag may have any name such as an IC tag, an IC card, or a responder.

The item management system 1 includes, in addition to the above-described position tags 20 and the item tags 40, a tag reader 100, a management server 200, and a user terminal 300. The tag reader 100, the management server 200, and the user terminal 300 are connected to a network 5. The network 5 may be a wired network, a wireless network, or any combination thereof. Examples of the network 5 may include the Internet, an intranet, and a cloud network.

The tag reader 100 is a reading apparatus that reads information from the RFID tags. The tar reader 100 is typically carried by a user and moves within a floor 10. The tag reader 100 performs reading periodically or in response to a certain trigger such as a user operation, and transmits a tag reading result to the management server 200. In addition, in the present embodiment, the tag reader 100 is capable of measuring a relative amount of movement in a real space. The tag reader 100 may be capable of communicating with the management server 200 directly or indirectly via a certain relay apparatus (for example, the user terminal 300). An example of a particular configuration of the tag reader 100 will be further described below.

The management server 200 is an information processing apparatus that uses a database to manage position information indicating positions of the position tags 20 and the item tags 40 in the real space. The management server 200 may be implemented as an application server, a database server, or a cloud server by using a high-end general-purpose computer, for example. In the present embodiment, positions within a floor 10 at which the position tags 20 are arranged are designated by a user in advance and registered in the database. Positions of the item tags 40 are determined based on data received from the tag reader 100 and stored in the database. The management server 200 may have an information provision function to provide a user with position information that indicates latest positions of tags or items under its management. An example of a particular configuration of the management server 200 will be further described below.

In the example in FIG. 1, the management server 200 is a cloud server deployed in a cloud environment. Though a single management server 200 is illustrated in FIG. 1, the management function of the management server 200, which will be described in detail below, may be provided by a single apparatus or by physically-separate multiple apparatuses which operate in conjunction with each other. In addition, though an example where the management server 200 maintains a database that stores above-described position information will be described in the present embodiment, an apparatus other than the management server 200 may maintain a part or all of the database. For example, a part of data may be maintained by a wireless device (for example, a position tag or an item tag) or by a tag reader.

The user terminal 300 is a terminal apparatus that is utilized by a user of the information processing system 1. The user terminal 300 may be a general-purpose terminal such as a tablet personal computer (PC), a laptop PC, or a smartphone, or a dedicated terminal specialized for position information management. The user terminal 300 typically comprises an input device that receives user inputs, a communication interface that communicates with other apparatuses (for example, the management server 200), and a display device that displays information. As an example, the user terminal 300 is utilized by a user when registering a position in the real space at which a position tag 20 should be arranged in the database, and when verifying a position of the position tag 20 that has been actually arranged. Examples of user interactions that may be performed via the user terminal 300 in these situations will further be described below.

It should be noted that, though FIG. 1 illustrates the tag reader 100 and the user terminal 300 as separate apparatuses, there may be provided an integrated apparatus which has both of functionalities of the tag reader 100 and the user terminal 300. Moreover, though FIG. 1 illustrates an example where a user carries the tag reader 100, the tag reader 100 may move within a floor 10 while being mounted on a movable machine (for example, a drone, a vehicle or a robot) instead of a user.

### 1-2. Configuration Example of Tag Reader

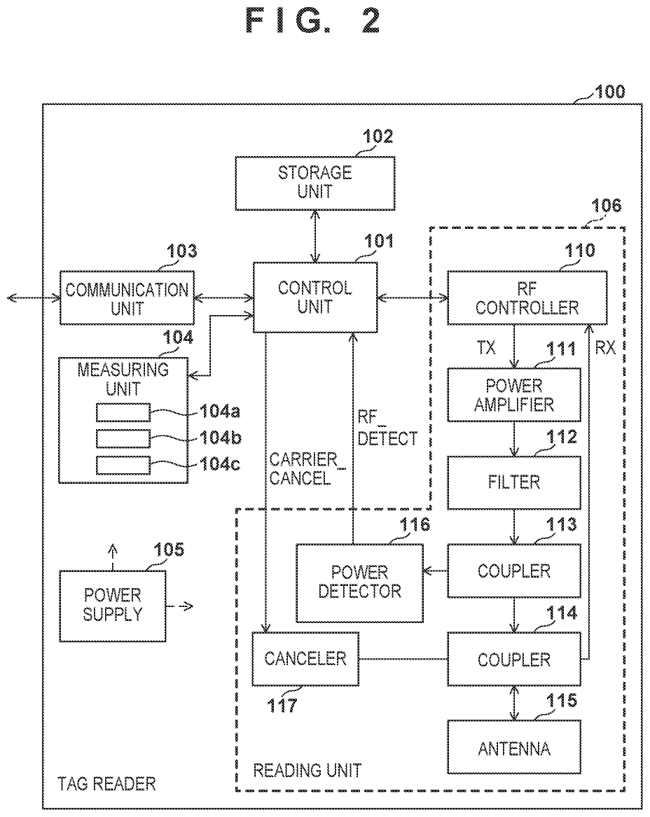

FIG. 2 is a block diagram illustrating an example of a configuration of the tag reader 100 according to the first embodiment. With reference to FIG. 2, the tag reader 100 comprises a control unit 101, a storage unit 102, a communication unit 103, a measuring unit 104, a power supply 105, and a reading unit 106.

The control unit 101 consists of a memory to store computer programs, and one or more processors (for example, central processing units (CPUs)) to execute the computer programs. The control unit 101 controls overall functionality of the tag reader 100 described in this specification. For example, the control unit 101 causes the reading unit 106 to perform reading from an RFID tag within a tag reading range, and causes the storage unit 102 to store the read information and the time of the reading as reading result data. In parallel to the reading from RFID tags, the control unit 101 also causes the measuring unit 104 to measure an amount of movement of the tag reader 100, and the storage unit 102 to store, as measurement result data, movement amount information indicating the measurement result and a measurement time. Then, the control unit 101 transmits, to the management server 200 via the communication unit 103, the reading result data and the measurement result data stored in the storage unit 102 together with the reader identification information of the tag reader 100.

The storage unit 102 may include any kind of storage medium such as a semiconductor memory (a read only memory (ROM), a random access memory (RAM), or the like), an optical disk, or a magnetic disk, for example. In the present embodiment, the storage unit 102 stores the above-described reading result data, measurement result data, and the reader identification information of the tag reader 100.

The communication unit 103 is a communication interface for the tag reader 100 to communicate with the management server 200. For example, the communication unit 103 may be a wireless local area network (WLAN) interface that communicates with a WLAN access point, or a cellular communication interface that communicates with a cellular base station. Alternatively, the communication unit 103 may be a connection interface (e.g. a Bluetooth (registered trademark) interface or a universal serial bus (USB) interface) for connection with a relay apparatus (for example, the user terminal 300).

In the present embodiment, the measuring unit 104 can measure an amount of relative movement of the tag reader 100 to output the measured amount of movement to the control unit 101. For example, the measuring unit 104 includes a three-axis acceleration sensor 104a, a gyro sensor 104b, and a geomagnetic sensor 104c. The three-axis acceleration sensor 104a measures acceleration applied to the tag reader 100 in the device coordinate system that is specific to the tag reader 100, and outputs first sensor data. The gyro sensor 104b measures an angular speed of the tag reader 100, that is, a change in attitude of the tag reader, to output second sensor data. The geomagnetic sensor 104c measures an orientation of the tag reader 100 in the real space to output third sensor data. The measuring unit 104 can measure the amount of relative movement of the tag reader 100 based on these pieces of sensor data by converting the direction of the acceleration of the tag reader 100 into a direction in a coordinate system of the real space to integrate the converted acceleration. The measurement of an amount of movement here may be performed in accordance with any publicly-known self-localization technique. The amount of relative movement output from the measuring unit 104 to the control unit 101 may be a two-dimensional vector in a surface of a floor 10, or a three-dimensional vector that includes a component of height direction as well. The reference position of measurement of the amount of relative movement may be, for example, the position of the tag reader 100 at the time when the tag reader 100 is activated.

It should be noted that, though FIG. 2 illustrates an example where the tag reader 100 includes the measuring unit 104, the measuring unit 104 may be included in an external device that is capable of communicating with the tag reader 100 and is carried by the user along with the tag reader 100. In that case, the tag reader 100 receives, from the external device, movement amount information indicating a relative amount of movement measured by the measuring unit 104.

The power supply 105 includes a battery and a DC-DC converter, and supplies power for operating electronic circuits of the control unit 101, the storage unit 102, the communication unit 103, the measuring unit 104 and the reading unit 106 of the tag reader 100. The battery may include a primary cell, or a rechargeable secondary cell. Although not illustrated in the figure, the tag reader 100 may have a connection terminal to connect the tag reader 100 to an external power source for recharging the power supply 105.

The reading unit 106 is a reading module that is capable of reading, from each of the position tags 20 and the item tags 40, identification information stored in the tag. With reference to FIG. 2, the reading unit 106 includes an RF controller 110, a power amplifier 111, a filter 112, a first coupler 113, a second coupler 114, an antenna 115, a power detector 116, and a canceler 117. The RF controller 110 outputs a transmission signal (for example, a signal modulated in the UHF band) from a TX terminal to the power amplifier 111 in accordance with control by the control unit 101. The power amplifier 111 amplifies the transmission signal input from the RF controller 110 to output it to the filter 112. The filter 112 may be a low-pass filter, for example, and filters out unnecessary frequency components from the transmission signal amplified by the power amplifier 111. The first coupler 113 distributes the transmission signal that has passed the filter 112 to the coupler 114 and the power detector 116. The second coupler 114 outputs the transmission signal input from the first coupler 113 to the antenna 115, and outputs a received signal input from the antenna 115 to the RF controller 110. The antenna 115 transmits the transmission signal input from the coupler 114 to the air as an electromagnetic wave. Further, the antenna 115 receives a signal that has been sent back from an RFID tag that exists within the reading range of the tag reader 100 in response to the transmission signal, and outputs the received signal to the coupler 114. The power detector 116 detects a power level of the signal input from the first coupler 113, and outputs a signal “RF_DETECT” indicative of the detected power level to the control unit 101. The canceler 117 receives a signal “CARRIER_CANCEL” indicative of a power level of a carrier from the control unit 101. Then, the canceler 117 extracts an intended signal component of the received signal to be output to an RX terminal of the RF controller 110 by canceling the carrier component of the transmission signal based on the CARRIER_CANCEL. The RF controller 110 demodulates the signal input from the RX terminal to obtain the tag ID and other information sent back from the RFID tag, and outputs the obtained information to the control unit 101.

In the present embodiment, the reading unit 106 can attempt tag reading periodically (for example, once per second) without requiring any explicit command from a user. Data transmission from the communication unit 103 to the management server 200 can also be performed periodically (for example, every few seconds) or whenever the tag reading is done or the measurement of relative movement is done without requiring any explicit command from a user. The control unit 101 may exclude, from the data to be transmitted, the same record as the most recent record that has already been transmitted in a predetermined time period to omit redundant data transmission and reduce a communication load. It should be noted that, in another embodiment, one or both of an attempt of tag reading by the reading unit 106 and data transmission to the management server 200 may be performed in response to a user input via a certain user interface arranged in the tag reader 100. In a case where the communication unit 103 performs communication with the management server 200 indirectly via a relay apparatus, the data transmission to the management server 200 may be performed only while there is an effective connection between the communication unit 103 and the relay apparatus.

### 1-3. Configuration Example of Management Server

### 1-3-1. Basic Configuration

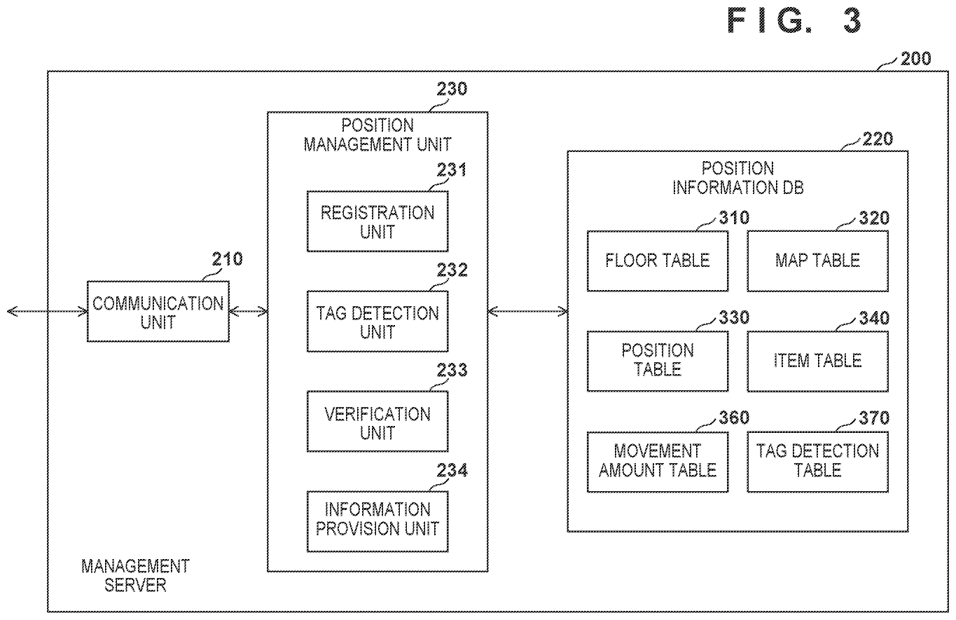

FIG. 3 is a block diagram illustrating an example of a configuration of the management server 200 according to the first embodiment. With reference to FIG. 3, the management server 200 comprises a communication unit 210, a position information database (DB) 220, and a position management unit 230.

The communication unit 210 is a communication interface for the management server 200 to communicate with other apparatuses. The communication unit 210 may be a wired communication interface or a wireless communication interface. In the present embodiment, the communication unit 210 communicates with the tag reader 100 and the user terminal 300 within the information processing system 1. The position information DB 220 consists of tables for managing data indicating positions of RFID tags under management of the system. In the present embodiment, the position information DB 220 includes a floor table 310, a map table 320, a position table 330, an item table 340, a movement amount table 360, and a tag detection table 370. The position management unit 230 is a set of software modules that provide management functions for managing data within the position information DB 220. The individual software modules can run by one or more processors (not shown) of the management server 200 executing computer programs stored in a memory (not shown). The memory herein may include a non-transitory computer-readable storage medium. In the present embodiment, the position management unit 230 includes a registration unit 231, a tag detection unit 232, a verification unit 233, and an information provision unit 234.

### 1-3-2. Data Configuration Examples

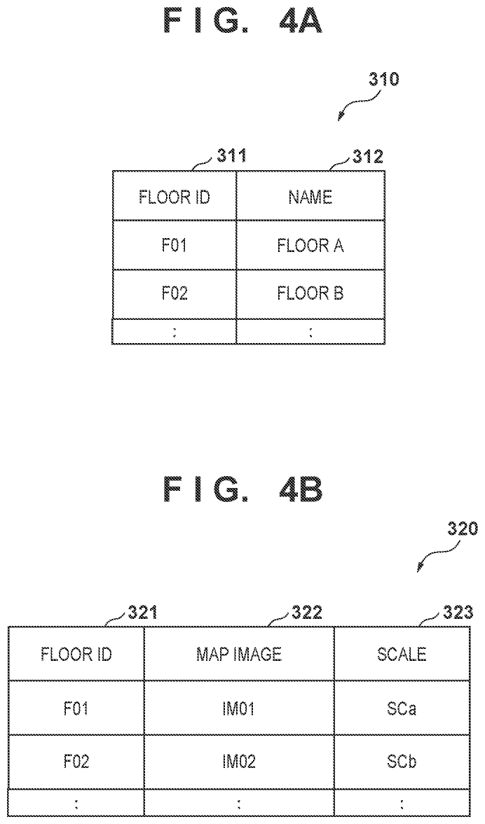

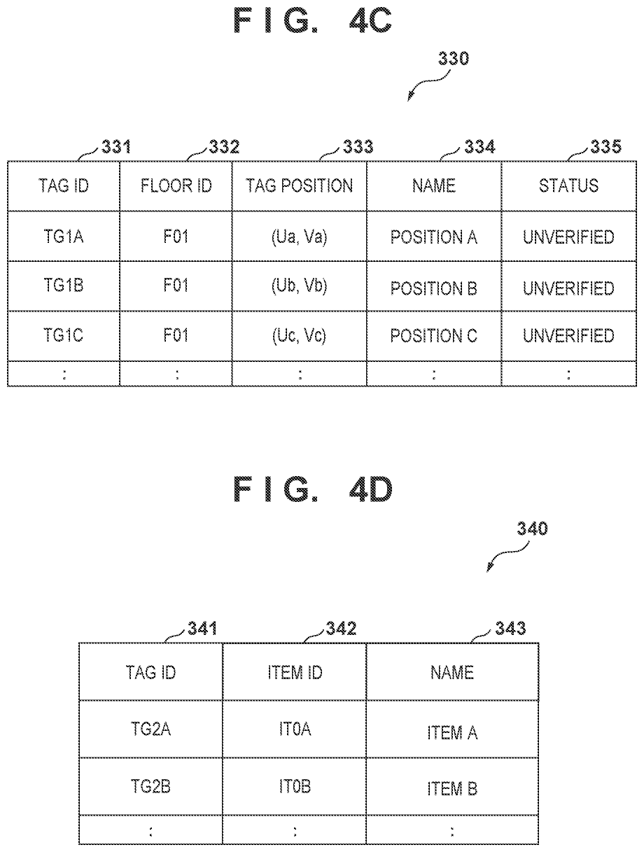

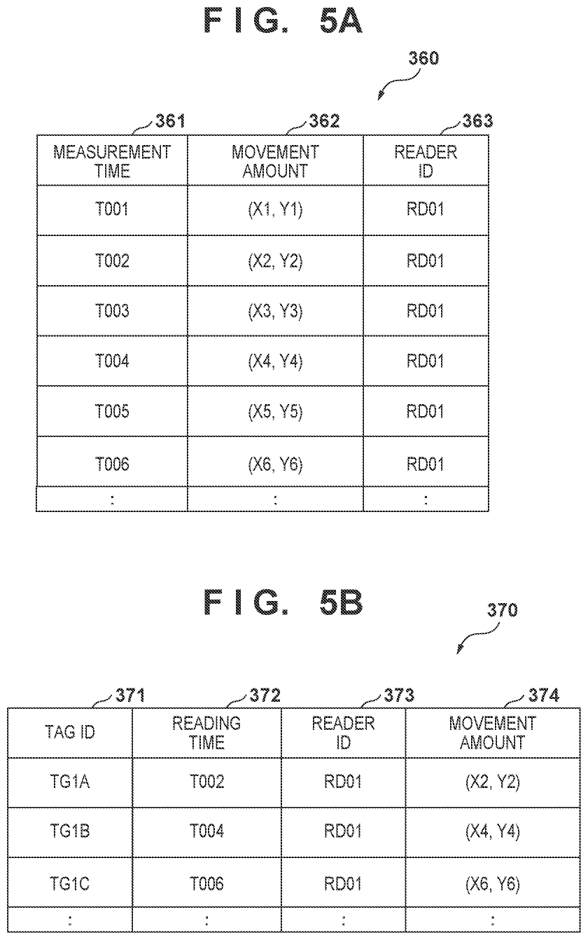

FIGS. 4A to 4D illustrate respective configuration examples of the floor table 310, the map table 320, the position table 330, and the item table 340 of the position information DB 220. FIGS. 5A and 5B illustrate respective configuration examples of the movement amount table 360 and the tag detection table 370 of the position information DB 220.

The floor table 310 has two data elements of Floor ID 311 and Name 312. Floor ID 311 is identification information that uniquely identifies each of the floors which are places where two or more position tags 20 may be arranged in the present embodiment. Name 312 represents a name of each floor. In the example of FIG. 4A, the name of the floor identified by Floor ID “F01” is “Floor A”, and the name of the floor identified by Floor ID “F02” is “Floor B”. Noted that “Floor A” and “Floor B” may be, in practice, names such as “1st floor, ABC building” and “2nd floor, ABC building”, for example.

The map table 320 has three data elements of Floor ID 321, Map Image 322, and Scale 323. Floor ID 321 indicates a floor 10 to be associated with a map image in the map table 320 using a value of Floor ID 311 of the floor table 310. Map Image 322 is a data element that stores map information indicating a map of a floor 10 identified by Floor ID 321. The map information here may typically be image information. Scale 323 indicates a ratio for converting a distance on a map of Map Image 322 into a distance in a real space (e.g., how many meters in a real space one pixel in an image corresponds to). It should be noted that map information stored in Map Image 322 may be updated by being obtained from an external data source, or by being uploaded by a user, at a necessary timing.

The position table 330 has five data elements of Tag ID 331, Floor ID 332, Tag Position 333, Name 334, and Status 335. Tag ID 331 is identification information that uniquely identifies each of position tags 20. A value of Tag ID 331 is the same as a value of a tag ID that has been stored inside a corresponding position tag 20. Floor ID 332 indicates a floor 10 on which each position tag 20 is arranged using a value of Floor ID 311 of the floor table 310. In the example of FIG. 4C, three position tags 20 identified by Tag IDs “TG1A”, “TG1B”, and “TG1C” are all arranged on a floor 10 identified by Floor ID “F01”. Tag Position 333 is a data element for storing the position coordinates indicating a device position of each position tag 20 in a real space in association with a tag ID of the position tag 20. Tag Position 333 may indicate a device position of each position tag 20 using a coordinate system of map information stored in Map Image 322; in this case, mutual conversion between coordinate values on a map and corresponding coordinate values in a real space can be performed using Scale 323. Name 334 indicates a name of a position at which each position tag 20 is arranged. In the example of FIG. 4C, Names 334 of three position tags 20 identified by Tag IDs “TG1A”, “TG1B”, and “TG1C” are respectively “Position A”, “Position B”, and “Position C”. It should be noted that “Position A”, “Position B”, and “Position C” may actually be such names as “Conference Room”, “Workroom”, and “Warehouse”, for example. Status 335 indicates a status of verification related to whether each position tag 20 is actually arranged at a device position indicated by Tag Position 333 of the position tag 20. For example, Status 335 indicates “Unverified” with respect to a position tag 20 that is yet to be verified, and indicates “Verified” with respect to a position tag 20 that has been determined to have been appropriately arranged at a device position indicated by Tag Position 333. In other words, with respect to a position tag 20 for which Status 335 indicates “Unverified”, Tag Position 333 indicates a device position within a real space at which the position tag 20 is supposed to be arranged. Also, with respect to a position tag 20 for which Status 335 indicates “Verified”, Tag Position 333 indicates a device position within a real space for which the arrangement of the position tag 20 has been verified.

The item table 340 has three data elements of Tag ID 341, Item ID 342, and Name 343. Tag ID 341 is identification information that uniquely identifies an item tag 40 attached to each of items under management of the system. A value of Tag ID 341 is the same as a value of a tag ID that has been stored inside a corresponding item tag 40. Item ID 342 is identification information that uniquely identifies each item. Name 343 indicates a name of each item. In the example of FIG. 4D, the name of an item identified by Tag ID “TG2A” or Item ID “IT0A” is “Item A”, and the name of an item identified by Tag ID “TG2B” or Item ID “IT0B” is “Item B”.

A movement amount table 360 illustrated in FIG. 5A is a table for accumulating records of measurement result data received from the tag reader 100 (hereinafter referred to as measurement result records). The movement amount table 360 has three data elements of Time of Measurement 361, Amount of Movement 362, and Reader ID 363. Time of Measurement 361 indicates the time at which the measurement was performed with respect to a measurement result indicated by each measurement result record. Amount of Movement 362 indicates an amount of relative movement of the tag reader 100 as a measurement result. The amount of relative movement can be indicated in the form of, for example, a two-dimensional vector in a real-space coordinate system. Reader ID 363 is identification information that identifies the tag reader 100 that performed the measurement with respect to a measurement result indicated by each measurement result record. In the example of FIG. 5A, six records in the movement amount table 360 indicate the results of measurements of amounts of movement that were performed by the same tag reader 100, which is identified by Reader ID “RD01”, at six different times “T001” to “T006”.

A tag detection table 370 illustrated in FIG. 5B is a table for accumulating records of reading result data received from the tag reader 100 (hereinafter referred to as reading result records). The tag detection table 370 has four data elements of Tag ID 371, Time of Reading 372, Reader ID 373, and Amount of Movement 374. Tag ID 371 indicates a tag ID that has been read with respect to each reading result record. Time of Reading 372 indicates the time at which a tag ID indicated by Tag ID 371 was read. Reader ID 373 is identification information that identifies the tag reader 100 that has performed tag reading with respect to the reading result indicated by each reading result record. In the example of FIG. 5B, the first record in the tag detection table 370 indicates that the tag reader 100 identified by the reader ID “RD01” read the tag ID “TG1A” at time “T002”. Amount of Movement 374 indicates an amount of relative movement of the tag reader 100 when tag reading indicated by each reading result record was performed (i.e., a relative position of the tag reader 100 on the floor 10 associated with the tag ID that has been read). In the example of FIG. 5B, the first record in the tag detection table 370 indicates that the tag reader 100 identified by the reader ID “RD01” was positioned at a point indicated by the relative position (X2, Y2) at time “T00T” at which the tag ID “TG1A” was read. In the present embodiment, a value of Amount of Movement 374 is not indicated by reading result data received from the tag reader 100, but is transcribed by the later-described tag detection unit 232 from Amount of Movement 362 of the movement amount table 360 based on a correlation between Time of Measurement 361 and Time of Reading 372. It should be noted that, in another embodiment, reading result data received from the tag reader 100 may indicate an amount of relative movement of the tag reader 100 at the time of tag reading. In this case, the tag reader 100 associates the result of measuring the amount of movement with the result of tag reading.

### 1-3-3. Pre-Registration

The registration unit 231 of the position management unit 230 receives, from a user of the information processing system 1, an issuance request that requests for the issuance of position tags 20. The issuance request received here can include, for example, a list of names of position tags 20 that are desired by the user to be arranged on a floor-by-floor basis. The issuance request may further include one or more of the floor ID, name, map information, and scale of each target floor. Based on the received issuance request, the registration unit 231 sets information of the target floor(s) in the floor table 310 and the map table 320. Furthermore, the registration unit 231 registers the designated number of tag IDs (of unused position tags 20), together with the designated names, in the position table 330 in association with a corresponding floor ID. The registration unit 231 may, for example, cause a display of the user terminal 300 to display an issuance request reception screen, and receive an issuance request on the issuance request reception screen. Alternatively, an operator of the information processing system 1 may receive information necessary for an issuance request from the user via, for example, an electronic mail, and input the received information on a screen of a terminal used by him/herself.

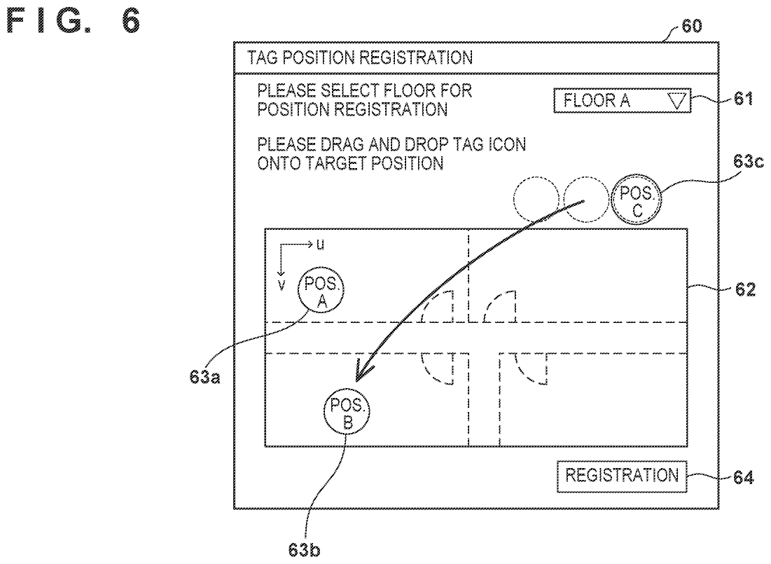

After registering, in the position table 330, the tag IDs and names in association with a corresponding floor ID, the registration unit 231 causes the display of the user terminal 300 to display a position registration screen 60, which is exemplarily illustrated in FIG. 6. Referring to FIG. 6, the position registration screen 60 includes a floor selection field 61, a map display area 62, tag icons 63a, 63b, and 63c, and a registration button 64. The floor selection field 61 is a UI for the user to select one of the floors that are candidates for an arrangement location of issued position tags 20. The map display area 62 is a display area that displays a map of the selected floor. For example, when “Floor A” has been selected in the floor selection field 61, the registration unit 231 causes the map display area 62 to display a map of “Floor A” based on the map information of selected “Floor A”. The tag icons 63 (63a, 63b, and 63c) are objects for the user to designate the arrangements of position tags 20 corresponding to the tag IDs that have been registered in association with the selected floor. It is assumed that, in the example of FIG. 6, three position tags 20 have been registered under the names of “Position A”, “Position B”, and “Position C”, respectively, in association with “Floor A”. The user drags and drops each tag icon 63 to a position on the map at which the corresponding position tag 20 is to be arranged. Once the user has finished arranging every tag icon 63 at an intended point on the map in the map display area 62, the user operates (e.g., taps) the registration button 64. Then, the registration unit 231 obtains coordinate values indicating drop positions of the respective tag icons 63, and registers the obtained coordinate values in the fields of Tag Position 333 of the position table 330 in association with the corresponding tag IDs.

The operator transfers (e.g., mails), to the user, a set of position tags 20 (physical devices) that respectively store the tag IDs registered in the position table 330. These position tags 20 have, for example, labels describing the registered names appended thereto, and are packaged and transferred for each of the floors that serve as arrangement locations. The user goes to a target floor in a real space while carrying the transferred position tags 20, and arranges the position tags 20 at their respective positions while viewing, for example, a screen of the user terminal 300 (a screen that displays registered device positions on a map via the above-described position registration screen 60).

The above-described operations result in realization of a state where a plurality of position tags 20 are arranged on each floor 10, and the position table 330 of the position information DB 220 indicates the positions of these position tags 20. However, there is sometimes a case where an operational error made by a user, or a change in a circumstance since the time of initial registration, causes a mismatch between device positions stored in the position table 330 and actual positions of position tags 20 arranged in a real space. Such a mismatch interferes with other system operations performed based on position information in the database (e.g., determination of the position of a target, such as the item 30). In view of this, in the present embodiment, the verification unit 233 of the position management unit 230 verifies whether the position of a position tag 20 detected by the tag detection unit 232 matches a device position indicated by the position table 330, as will be described below in detail.

### 1-3-4. Detection of Tags

The tag detection unit 232 adds, to the movement amount table 360, one or more records of measurement result data received from the tag reader 100 via the communication unit 210. As described above, measurement result data includes movement amount information that indicates an amount of relative movement of the tag reader 100 that has been measured by the measuring unit 104 of the tag reader 100. Furthermore, the tag detection unit 232 adds, to the tag detection table 370, one or more records of reading result data received from the tag reader 100. As described above, reading result data includes a tag ID of an RFID tag that has been read by the reading unit 106 of the tag reader 100. The RFID tag here is either a position tag 20 or an item tag 40. With respect to each reading result record added to the tag detection table 370, the tag detection unit 232 extracts a measurement result record which includes the time of measurement closest to the time of reading indicated by the record (and which has been received from the same tag reader 100) from the movement amount table 360. Then, the tag detection unit 232 additionally writes a value of the amount of movement indicated by the extracted measurement result record to the field of Amount of Movement 374 in the corresponding reading result record. As a result, it becomes possible to estimate the positions of the respective position tags 20 and item tags 40 detected by the tag reader 100 in a real space (relative positions thereof in relation to a reference position of measurement of amounts of movement) from the values of Amount of Movement 374 of the tag detection table 370. An error of this estimation is approximately equal to the reading range of the tag reader 100 at most.

### 1-3-5. Verification of Arrangements

The verification unit 233 verifies the arrangements of position tags 20 in a real space conducted by the user. More specifically, the verification unit 233 determines whether a first positional relationship between tags that is estimated for two or more position tags 20 arranged in a real space matches a second positional relationship between corresponding device positions stored in the position table 330 of the position information DB 220. That is to say, the verification unit 233 also functions as a determination unit that makes a determination about consistency between the first and second positional relationships. The first positional relationship here denotes a relative relationship between estimated positions indicated by Amount of Movement 374 of the tag detection table 370 described above. The second positional relationship denotes a relative relationship between registered device positions (hereinafter also referred to as registered positions) indicated by Tag Position 333 of the position table 330. In the present embodiment, the position table 330 stores the device position of each position tag 20 in association with one of the plurality of floors 10 in a real space. Therefore, the verification unit 233 can verify the arrangements by comparing the first and second positional relationships with respect to two or more position tags 20 associated with the same floor. By thus limiting the target of verification to the positional relationships between position tags 20 arranged on the same floor, complication of verification algorithms can be avoided, and furthermore, position tags 20 that require correction can be narrowed down with ease.

The verification unit 233 can, for example, determine that the first positional relationship matches the second positional relationship in a case where a misalignment of the estimated position in the first positional relationship with respect to the corresponding device position in the second positional relationship falls below a tolerance for any position tag 20 subject to the verification. The tolerance here may be a magnitude enough to absorb an error in tag reading-based position estimation (e.g., several meters).

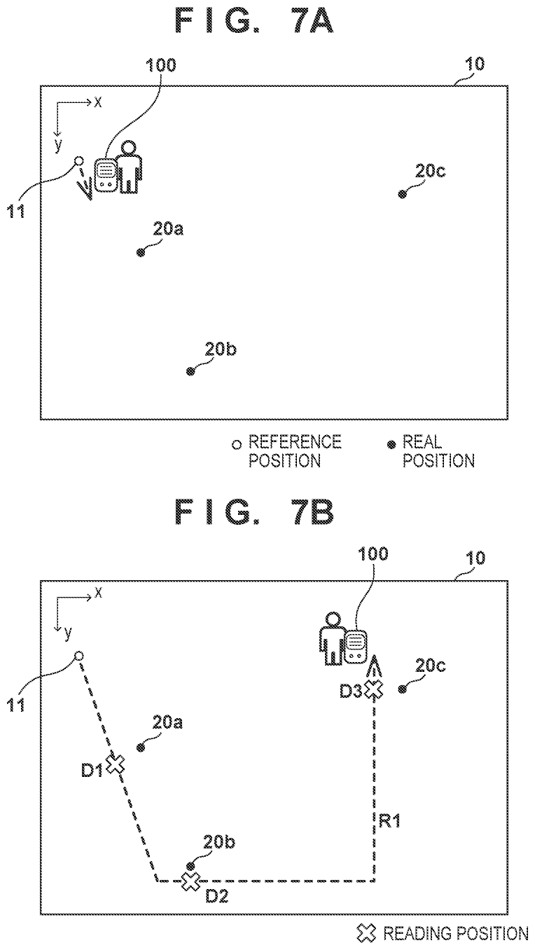

FIG. 7A and FIG. 7B are explanatory diagrams for explaining reading of tag IDs from position tags 20 arranged in a real space. FIG. 7A illustrates a state immediately after the user has activated the tag reader 100 at a reference position 11 after position tags 20a, 20b, and 20c have been arranged on a floor 10. In the figure, solid circles denote the actual positions of the respective position tags 20, and an open circle denotes the reference position. Using the reference position 11 as the origin, the measuring unit 104 of the tag reader 100 starts measuring the amounts of movement of the tag reader 100 in a coordinate system (x, y) in a real space. FIG. 7B illustrates reading positions D1, D2, and D3 at which the tag reader 100 have read the tag IDs from the position tags 20a, 20b, and 20c, respectively, when the user has moved along a dash-line arrow R1 on the floor 10. The tag detection unit 232 additionally writes coordinate values indicating the position of the reading position D1 (an amount of relative movement) in the field of Amount of Movement 374 of the record corresponding to the position tag 20a of the tag detection table 370. The same goes for the reading positions D2 and D3 of the position tags 20b and 20c. The verification unit 233 estimates that the position tags 20a, 20b, and 20c are positioned at these reading positions D1, D2, and D3, respectively.

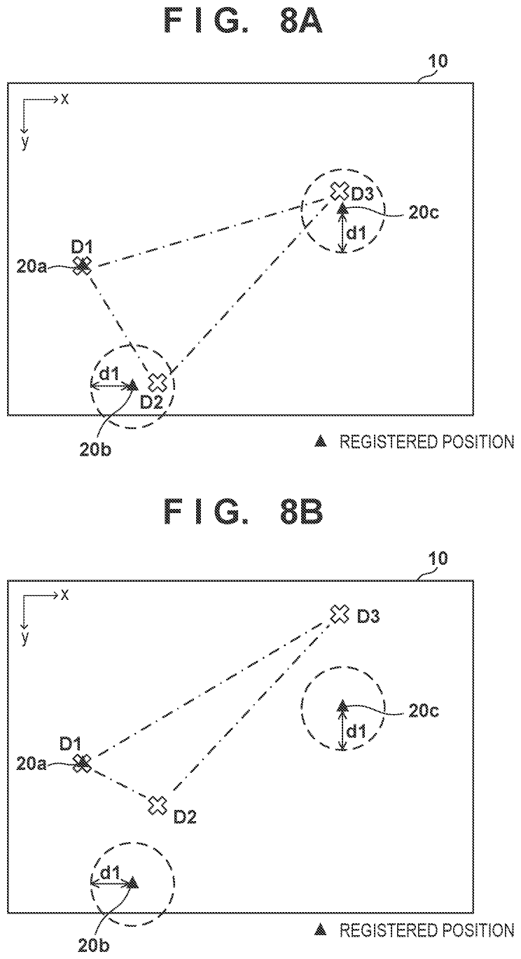

FIG. 8A and FIG. 8B are explanatory diagrams for explaining the comparison between the first positional relationship and the second positional relationship in the verification unit 233. Solid triangles illustrated in FIG. 8A and FIG. 8B denote registered positions that have been stored in the position table 330 in correspondence with the position tags 20a, 20b, and 20c, which have been described in relation to FIG. 7A and FIG. 7B. In the example of FIG. 8A, reading positions D1, D2, and D3 are the same as the positions illustrated in FIG. 7B. Here, when the reading position D1 of the position tag 20a has been brought to coincide with the registered position, a misalignment of the reading position D2 relative to the registered position of the position tag 20b is smaller than a tolerance dl (the reading position D2 falls within a circle representing a tolerance range that has a radius d1 and is centered at the registered position of the position tag 20b). Similarly, when the reading position D1 of the position tag 20a has been brought to coincide with the registered position, a misalignment of the reading position D3 relative to the registered position of the position tag 20c is also smaller than the tolerance d1 (the reading position D3 falls within a circle representing a tolerance range that has a radius d1 and is centered at the registered position of the position tag 20c). The verification unit 233 makes such a determination also in a case where the reading position D2 of the position tag 20b has been brought to coincide with the registered position, and a case where the reading position D3 of the position tag 20c has been brought to coincide with the registered position. Then, the verification unit 233 determines that the first positional relationship matches the second positional relationship when the positional misalignment falls below the tolerance d1 in all cases. On the other hand, the verification unit 233 determines that the first positional relationship does not match the second positional relationship when the positional misalignment exceeds the tolerance d1 in one or more cases. In this way, not determining that the relationships are mismatched when the positional misalignment between the two positional relationships falls below the tolerance can mitigate the influence on the determination from a measurement error in amounts of relative movement of the tag reader 100, or from an estimation error due to estimating a reading position of a tag as a position of the tag.

In the example of FIG. 8B, reading positions D1, D2, and D3 are different from the positions illustrated in FIG. 7B. When the reading position D1 of the position tag 20a has been brought to coincide with the registered position, a misalignment of the reading position D2 relative to the registered position of the position tag 20b is larger than the tolerance d1 (the reading position D2 does not fall within a circle representing a tolerance range that has a radius d1 and is centered at the registered position of the position tag 20b). Similarly, when the reading position D1 of the position tag 20a has been brought to coincide with the registered position, a misalignment of the reading position D3 relative to the registered position of the position tag 20c is larger than the tolerance d1 (the reading position D3 does not fall within a circle representing a tolerance range that has a radius d1 and is centered at the registered position of the position tag 20c). Therefore, in this case, the verification unit 233 determines that the first positional relationship does not match the second positional relationship.

Although FIG. 7A to FIG. 8B illustrate an example where three position tags 20 are subject to verification, the number k of position tags 20 subject to a verification at one time is not limited to this example. In a case where M position tags 20 are arranged on a floor 10, the number k of position tags 20 subject to a verification at one time may be any number that satisfies 2≤k≤M.

The verification unit 233 may change the value of the tolerance d1 depending on the progress status of verification. For example, the verification unit 233 may set the tolerance d1 at a certain value in a case where none of arrangements for all position tags 20 has been verified, and increase the value of the tolerance dl with an increase in the number of verified position tags 20. This makes it possible to actively notify the user of a possibility of an error and prompt him/her to make a correction at the time of initial adoption of a system which is likely to include an erroneous arrangement or registration, and offer flexibility in tag arrangements by tolerating a certain extent of positional misalignment after time has elapsed since the adoption.

In a case where the verification unit 233 has determined that the first positional relationship matches the second positional relationship, it changes the value of Status 335 in the position table 330 to “Verified” for position tags 20 that have been subject to the verification. Also, the verification unit 233 notifies the user of successful verification of arrangements on the screen of the user terminal 300. For example, based on the map information of the map table 320, the verification unit 233 may cause the screen of the user terminal 300 to display a map of the floor 10 such that the positions of the position tags 20 that have been successfully verified are mapped thereon.

On the other hand, in a case where the verification unit 233 has determined that the first positional relationship does not match the second positional relationship, it presents the result of this determination to the user on the screen of the user terminal 300. In this case as well, based on the map information of the map table 320, the verification unit 233 causes the screen to display a map of the floor 10 such that the positions (reading positions or registered positions) of the position tags 20 that have been subject to the verification are mapped thereon. In a case where it can be determined with a high probability that registrations or arrangements for specific position tags 20 are erroneous, the verification unit 233 may perform a notification in a mode in which these specific position tags 20 are distinguishable (e.g., by using a different color for tag icons, by causing tag icons to flash, or the like). As an example, in a case where the verification statuses of one or more position tags 20 are already “Verified”, there is a high possibility that the registration or arrangement of a position tag 20 is erroneous if the reading position thereof is outside the tolerance range when the registered positions of the verified position tags 20 have been brought to coincide with the reading positions. As another example, for each i that falls in a range of 1≤i≤k, the verification unit 233 may count the number Ni of position tags 20 whose reading positions are outside the tolerance range when the registered position of the i^{th} position tag 20 to be verified has been brought to coincide with the reading position. In this case, the verification unit 233 may determine that there is a high possibility that the registration or arrangement of a position tag 20 is erroneous if the reading position thereof is outside the tolerance range in the case of i with which Ni becomes the smallest. By mapping the result of the determination to a map and presenting the map on the screen, the user can visually and intuitively understand for which position tag 20 the user should take a corrective action.

Together with the presentation of the result of the determination indicating that the first positional relationship does not match the second positional relationship to the user, the verification unit 233 may prompt the user to take one or more of the following actions A1 to A3 on the screen:
A1) Correct the arrangement of a position tag 20 in a real space;
A2) Designate a position tag 20 that the user knows has been appropriately arranged at a corresponding registered position; and
A3) Designate a position tag 20 for which a corresponding registered position should be corrected in the position information DB 220.

In a case where the user has taken the action A1, the user can use the tag reader 100 to re-read the tag ID of the position tag 20 whose arrangement has been corrected, re-transmit reading result data to the management server 200, and request the management server 200 to re-verify the arrangement. On the other hand, the actions A2 and A3 can be taken on the screen of the user terminal 300.

In a case where the action A2 has been taken, that is to say, in a case where an appropriately-arranged position tag 20 has been designated after the result of the determination indicating that the two positional relationships do not match being presented, the verification unit 233 changes the value of Status 335 corresponding to the designated position tag 20 to “Verified”. Then, the verification unit 233 further determines which position tag 20 has been erroneously arranged, other than the designated position tag 20, based on the comparison between above-described first and second positional relationships.

In this case, using the arrangement of the position tag 20 that has been verified as a base, a position tag 20 that has been erroneously registered or arranged can be specifically identified; as a result, resolution of the status of the mismatch between the positional relationships can be facilitated via a user interaction.

In a case where the action A3 has been taken, that is to say, in a case where a position tag 20 for which a corresponding registered position should be corrected has been designated after the result of the determination indicating that the two positional relationships do not match being presented, the verification unit 233 corrects the registered content of the position information DB 220 in accordance with this designation. Specifically, the verification unit 233 corrects the registered position that is indicated by Tag Position 333 in the position table 330 in correspondence with the designated position tag 20, to a position estimated based on the first positional relationship. For instance, in the example of FIG. 8B, in a case where the user has designated the position tag 20b for correction of the registered position thereof, the verification unit 233 can correct the registered position of the position tag 20b to indicate the reading position D2. Via the above-described user interactions, the user can swiftly correct a device position that has been erroneously registered, following the operation for verifying the arrangements.

### 1-3-6. Provision of Position Information

Based on data maintained in the position information DB 220, the information provision unit 234 provides the user with position information indicating positions of items 30 or the tag reader 100 under management of the information processing system 1. For example, after the above-described verification of the arrangements of position tags 20 has succeeded, reading result records indicating results of tag reading for position tags 20 and item tags 40 are sequentially stored in the tag detection table 370. The information provision unit 234 can cause the screen of the user terminal 300 to display the latest positions of the items 30 based on the registered positions of the position tags 20, which are used as the base, and on the relative positions of the items 30 indicated by the values of Amount of Movement 374 in these reading result records.

### 1-4. Flows of Processes

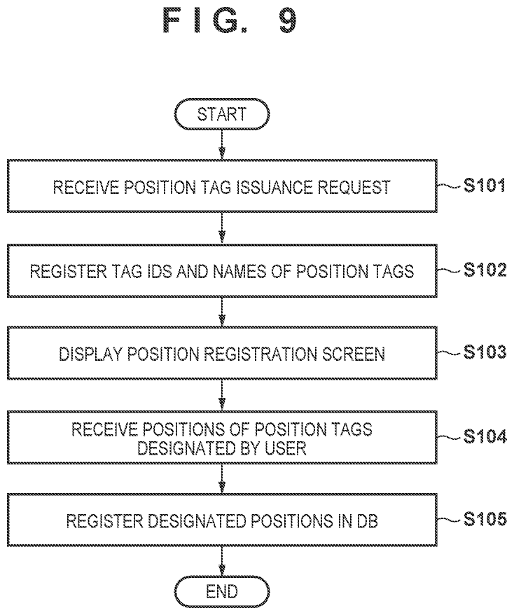

In the present section, examples of flows of several processes that can be executed by the management server 200 in the present embodiment will be described using the flowcharts of FIG. 9 to FIG. 14. It should be noted that, in the following description, a process step will be abbreviated as S (step).

### 1-4-1. Position Registration Process

FIG. 9 is a flowchart illustrating an example of a flow of a position registration process that can be executed by the registration unit 231 of the position management unit 230 according to the present embodiment.

First, in S101, the registration unit 231 receives a position tag issuance request via a reception screen that can be presented to a user or an operator of the system. Next, in S102, the registration unit 231 registers the tag IDs and names of the number of position tags 20 designated by the received issuance request in the position table 330 of the position information DB 220, in association with a floor ID of a designated floor 10. Next, in S103, the registration unit 231 causes the display of the user terminal 300 to display the position registration screen 60, which has been described using FIG. 6. On the position registration screen 60, the user designates the positions at which the respective position tags 20 should be arranged by, for example, operating the tag icons 63. Next, in S104, the registration unit 231 receives the positions of the respective position tags 20 that have been designated by the user via the position registration screen 60. Next, in S105, the registration unit 231 registers the designated positions that have been received in relation to the respective position tags 20 in the position table 330 of the position information DB 220. Then, the position registration process of FIG. 9 is ended.

### 1-4-2. Position Verification Process

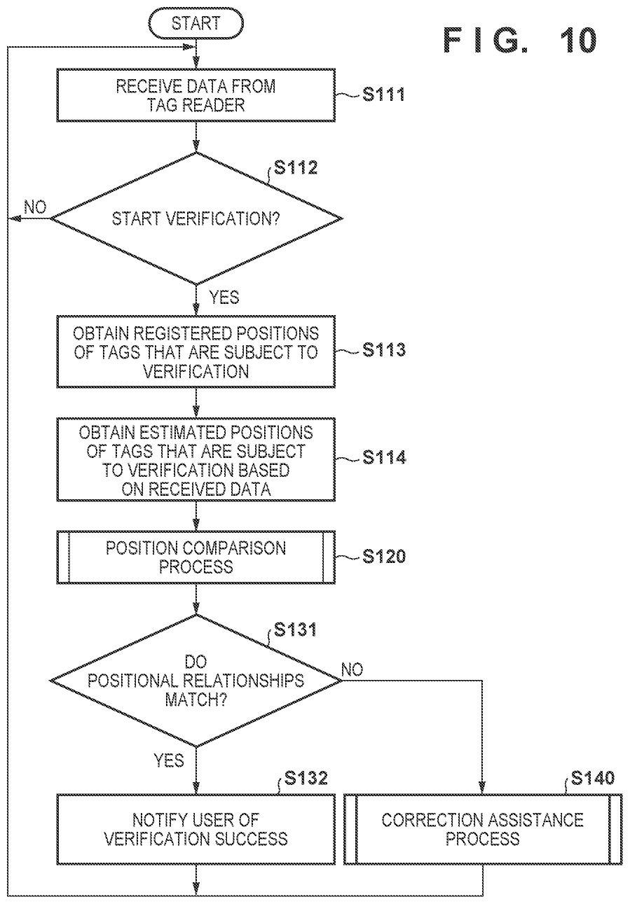

FIG. 10 is a flowchart illustrating an example of a flow of a position verification process that can be executed by the tag detection unit 232 and the verification unit 233 of the position management unit 230 according to the present embodiment.

In S111, the tag detection unit 232 waits for reception of data from the tag reader 100. When measurement result data has been received from the tag reader 100, the tag detection unit 232 stores one or more records of the measurement result data to the movement amount table 360. Furthermore, when reading result data has been received from the tag reader 100, the tag detection unit 232 stores one or more records of the reading result data to the tag detection table 370, and adds values of Amount of Movement 374 in the respective records obtained from the movement amount table 360.

In S112, the verification unit 233 monitors the tag detection table 370, and determines whether to start verification of arrangements of position tags 20. For example, the verification unit 233 may determine that the verification of arrangements is to be started in a case where the tag detection table 370 stores the results of tag reading from two or more position tags 20 associated with the same floor 10, and the status of at least one of them is “Unverified”. In a case where the verification unit 233 has determined that the verification of arrangements is to be started, the process proceeds to S113. In a case where the verification of arrangements is not to be started, the process returns to S111, and the reception of data from the tag reader 100 and the accumulation of data in the position information DB 220 are repeated.

In S113, the verification unit 233 obtains the registered positions of the two or more position tags 20 to be verified from the position table 330. At this time, the verification unit 233 may convert the position coordinates of the respective position tags 20 that have been registered as the coordinate values on a map into the coordinate values in a real space using the value of Scale 323 in the map table 320. Next, in S114, the verification unit 233 obtains the estimated positions of the position tags 20 to be verified, which are based on the data received from the tag reader 100, from the tag detection table 370. Next, in S120, the verification unit 233 executes a position comparison process for comparing the first positional relationship among the estimated positions of the position tags 20 to be verified, which have been obtained in S114, with the second positional relationship among the corresponding registered positions, which have been obtained in S113. An example of a more specific flow of the position comparison process executed here will be described below.

Thereafter, the process bifurcates depending on whether it has been determined in S131 that the first and second positional relationships match as a result of the position comparison process. In a case where it has been determined that the first and second positional relationships match, the process proceeds to S132. On the other hand, in a case where it has been determined that the first and second positional relationships do not match, the process proceeds to S140. In S132, the verification unit 233 notifies the user of successful verification of arrangements with respect to the position tags 20 that have been subject to the verification. On the other hand, in S140, the verification unit 233 executes a correction assistance process. An example of a more specific flow of the correction assistance process executed here will be described below. Thereafter, the process returns to S111, the reception of data from the tag reader 100 and the accumulation of data in the position information DB 220 are repeated, and verification of arrangements of position tags 20 is performed again as necessary.

### 1-4-3. Position Comparison Process

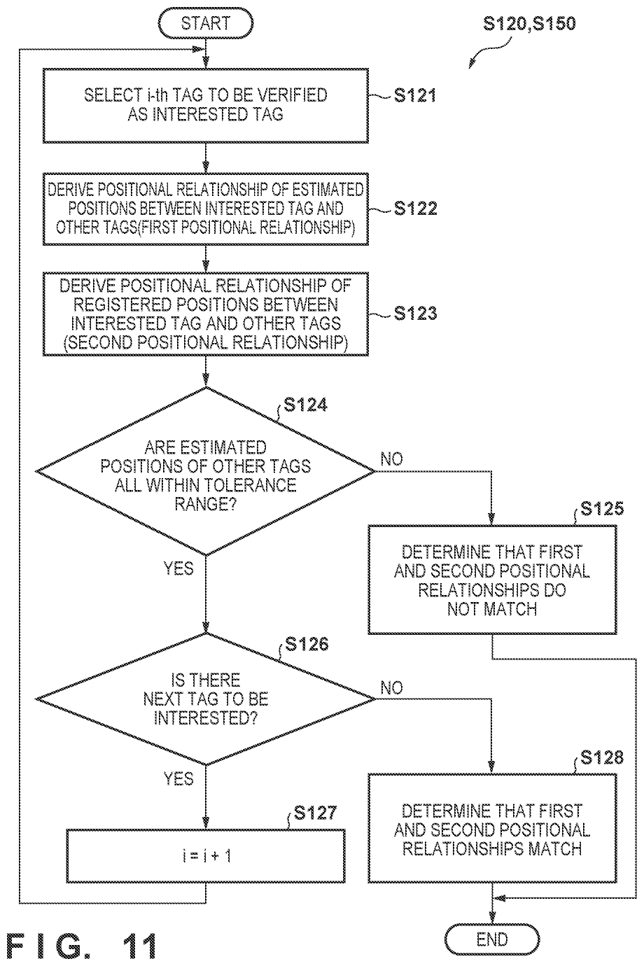

FIG. 11 is a flowchart illustrating an example of a flow of the position comparison process that can be executed in S120 of FIG. 10.

First, in S121, the verification unit 233 selects, from among k position tags 20 to be verified, the i^{th} tag (i=1, 2, . . . , k) as an interested tag.

Next, in S122, the verification unit 233 derives a positional relationship between the estimated position of the interested tag and the estimated positions of the other k−1 tags (the first positional relationship). For example, the verification unit 233 derives relative estimated positions for the other respective tags with respect to the interested tag, by subtracting a movement amount vector of the interested tag from movement amount vectors of the other respective tags.

Next, in S123, the verification unit 233 derives a positional relationship between the registered position of the interested tag and the registered positions of the other k−1 tags (the second positional relationship). For example, the verification unit 233 derives relative registered positions for the other respective tags with respect to the interested tag, by subtracting the registered position of the interested tag after coordinate conversion from the registered positions of the other respective tags after coordinate conversion.

Next, in S124, the verification unit 233 compares misalignments of the relative estimated positions of the other tags derived in S122 relative to the corresponding relative registered positions derived in S123 with the tolerance d1. Here, in a case where the misalignment of the estimated position relative to the registered position exceeds the tolerance dl for at least one tag, the verification unit 233 determines that the first and second positional relationships do not match in S125. On the other hand, in a case where the misalignments of the estimated positions relative to the registered positions are equal to or smaller than the tolerance d1 for all of the other k−1 tags, the process proceeds to S126.

In S126, the verification unit 233 determines whether there remains a tag to be interested next in the position tags 20 that are subject to the verification. In a case where there is a tag to be interested next, the variable i is incremented (i=i+1) in S127, and the above-described S121 to S126 are repeated using the (i+1)^{th} position tag 20 as an interested tag. In a case where there remains no tag to be interested next, the verification unit 233 determines that the first and second positional relationships match in S128. Then, the position comparison process of FIG. 11 is ended.

### 1-4-4. Correction Assistance Process

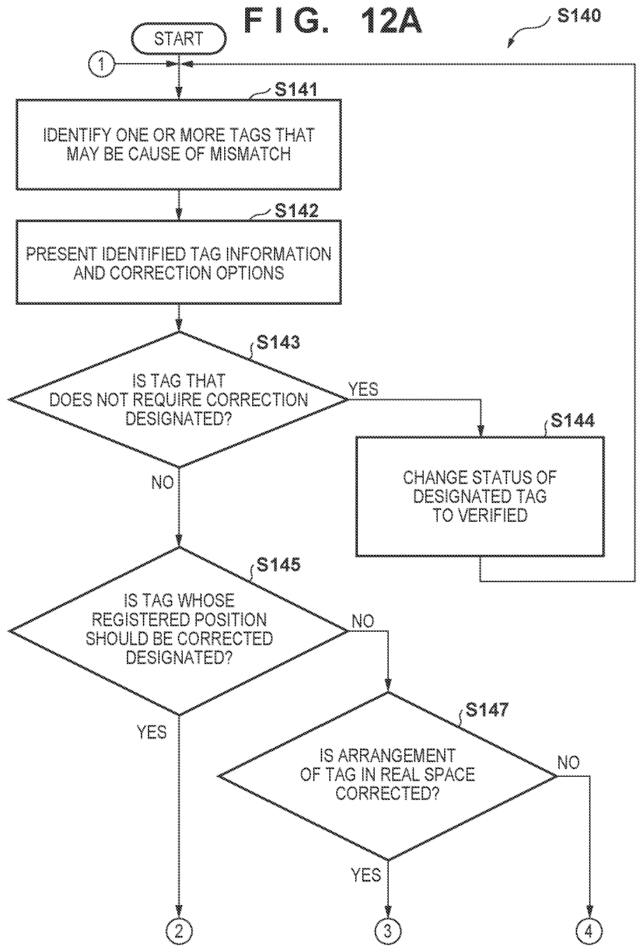

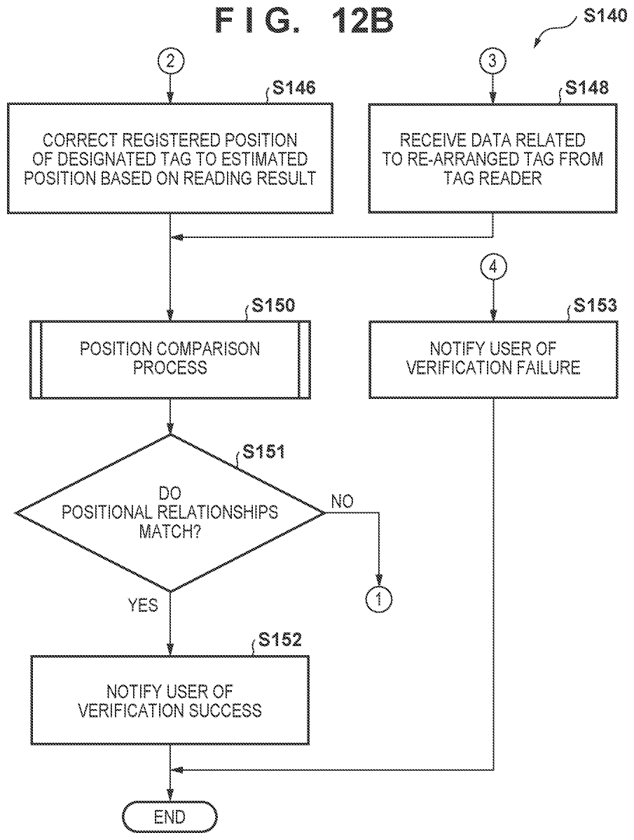

FIG. 12A and FIG. 12B are flowcharts illustrating an example of a flow of the correction assistance process that can be executed in S140 of FIG. 10. It is assumed here that one or both of the arrangement of a position tag 20 in a real space and a device position registered in the position information DB 220 is corrected via an interaction with a user.

First, in S141, the verification unit 233 identifies one or more tags that have a possibility of being the cause of the mismatch between the two positional relationships. For example, in a case where the statuses of all of the position tags 20 that are subject to the verification are “Unverified”, the verification unit 233 may determine that all of the position tags 20 subject to the verification have a possibility of being the cause of the mismatch. Furthermore, in a case where the status(es) of some of the position tags 20 is “Verified”, the verification unit 233 may determine that a position tag 20 has a possibility of being the cause of the mismatch if a misalignment between the estimated position and the registered position of that position tag 20 exceeds the tolerance when a “Verified” position tag 20 is used as a base.

Next, in S142, the verification unit 233 presents options for a corrective action (e.g., the above-described actions A1 to A3) to the user, together with information of the position tag(s) 20 identified in S141. Thereafter, the process bifurcates depending on the action selected by the user.

For example, in a case where the user has selected a position tag 20 which has been appropriately arranged and hence for which neither correction of the arrangement nor correction of the registered position is required (S143-Yes), the verification unit 233 changes the status of the designated position tag 20 to “Verified” in S144. Then, the process returns to S141, where one or more tags that have a possibility of being the cause of the mismatch are identified again.

Furthermore, in a case where the user has designated a position tag 20 for which the registered position should be corrected (S145-Yes), the verification unit 233 corrects the registered position of the designated position tag 20 to an estimated position based on the result of tag reading in S146. At this time, the verification unit 233 can change the status of the designated position tag 20 to “Verified”. Then, in S150, the verification unit 233 executes the position comparison process, which has been described using FIG. 11, again.

Furthermore, in a case where the user has corrected the arrangement of the position tag 20 in a real space (S147-Yes), measurement result data and reading result data related to the re-arranged position tag 20 are received from the tag reader 100 in S148. Then, in S150, the verification unit 233 executes the position comparison process, which has been described using FIG. 11, again based on the record that has been newly added to the tag detection table 370 by the tag detection unit 232.

In a case where it has been determined that the first and second positional relationships match in S151 as a result of the re-execution of the position comparison process in S150, the verification unit 233 notifies the user of successful verification in S152. Then, the correction assistance process of FIG. 12A and FIG. 12B are ended. On the other hand, in a case where it has been determined that the first and second positional relationships do not match, the process returns to S141, and one or more tags that have a possibility of being the cause of the mismatch are identified again.

In a case where none of the corrective actions is taken by the user (S147-No), the verification unit 233 notifies the user of failed verification in S153. Then, the correction assistance process of FIG. 12A and FIG. 12B are ended.

### 1-4-5. Correction Assistance Process (First Alteration Example)

FIG. 13 is a flowchart illustrating an example of a flow of a correction assistance process according to a first alteration example of the first embodiment. In the first alteration example, a bidirectional interaction with the user is not performed, and the user is simply notified of failed verification of the arrangements of position tags 20.

Referring to FIG. 13, first, the verification unit 233 identifies one or more position tags 20 that have a possibility of being the cause of the mismatch between the two positional relationships in S141. Next, in S155, the verification unit 233 notifies the user of failed verification, together with information of one or more position tags 20 that have been identified. For example, the verification unit 233 can cause the display of the user terminal 300 to display a map that shows tag icons indicating the names of the identified position tags 20 at the reading positions or the registered positions of these tags, together with a message representing a notification of failed verification. Upon receiving such a notification, the user is expected to take a necessary action for achieving an appropriate status, such as movement of position tags 20 that have been arranged at wrong positions to appropriate positions.

### 1-4-6. Automatic Correction Process (Second Alteration Example)

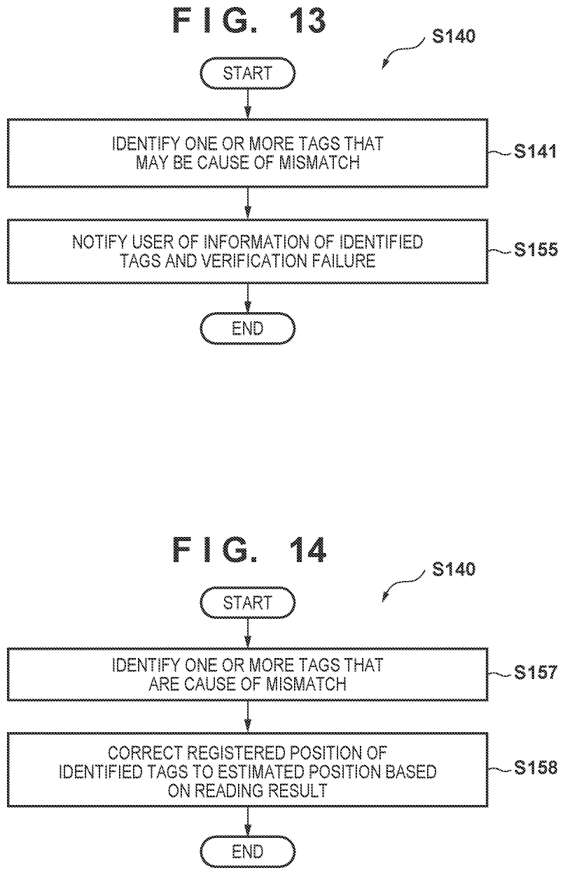

FIG. 14 is a flowchart illustrating an example of a flow of an automatic correction process according to a second alteration example of the first embodiment. In the second alteration example, for example, in a case where the statuses of one or more position tags 20 are “Verified” and it has been known that their arrangements are accurate, the registered positions of unverified position tags 20 are automatically corrected using the position of a verified position tag 20 as a base. That is to say, in a case where the verification unit 233 has determined that the first positional relationship does not match the second positional relationship, the registered positions of position tags 20 are corrected to match the first positional relationship by executing the automatic correction process to be described below in place of the above-described correction assistance process in S140 of FIG. 10.

Referring to FIG. 14, first, the verification unit 233 identifies one or more position tags 20 that are the cause of the mismatch between the two positional relationships in S157. Next, in S158, the verification unit 233 corrects the position coordinates of the registered positions indicated by Tag Position 333 in the position table 330 for the one or more identified position tags 20 to the position coordinates of estimated positions based on the result of tag reading. Then, the verification unit 233 changes the values of Status 335 in the same records in the position table 330 to “Verified”. Allowing such automatic correction of registered positions can alleviate a work load on the user required to register position information.

### 1-5. Summary of First Embodiment

According to the first embodiment, a determination is made for two or more RFID tags arranged in a real space about whether the first positional relationship among the estimated positions of these RFID tags based on a result of tag reading matches the second positional relationship among corresponding device positions registered in a database. Then, in a case where it has been determined that the first and second positional relationships do not match, the system assists the actions taken by the user to resolve the state of the mismatch, or automatically executes processes for resolving the state of the mismatch, based on the result of the determination. The above-described configuration can easily detect and resolve a misalignment between a device position indicated by registered information of the system and an actual arrangement of a device in a real space, without depending on electric waves from a satellite, such as a GPS satellite. Therefore, even in a space where GPS-based technology does not function effectively, such as the inside of a building or underground, RFID tags can be swiftly arranged at appropriate points, and these tags can be utilized for various purposes, including a determination of a position or tracking of a mobile item. Furthermore, as there is no need to implement a GPS function in a tag reader that reads tag IDs from the RFID tags, the cost of adoption of the tag reader, as well as the size of the tag reader, can be easily reduced.

### 2. Second Embodiment

The above first embodiment has been described mainly in relation to an example where a misalignment between a device position indicated by registered information and an actual arrangement of a device is detected at the time of initial arrangement of RFID tags in a real space. In contrast, a second embodiment described in the present section pertains to an example where whether an item that can move over time is at a correct position is detected using a similar mechanism in a state where several RFID tags have already been arranged appropriately in a real space.

### 2-1. System Overview

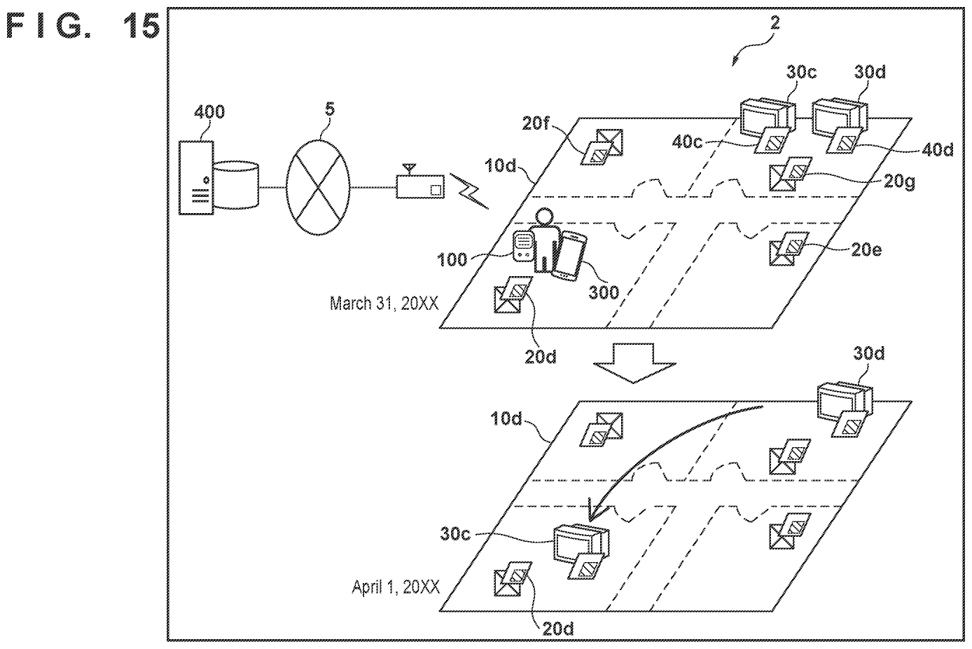

FIG. 15 is a schematic view illustrating an example of a configuration of an information processing system 2 according to the second embodiment. In the example of FIG. 15, position tags 20d, 20e, 20f, and 20g are arranged on a floor

These are RFID tags similar to the position tags 20 according to the first embodiment. Although FIG. 15 illustrates only one floor 10d, more floors 10 may exist. An item 30c to which an item tag 40c is attached, and an item 30d to which an item tag 40d is attached, exist on the floor 10d. As of March 31, 20XX, the items 30c and 30d are positioned in a section near the position tag 20g (see the upper level of the figure); meanwhile, as of April 1, 20XX, the item 30c has moved to another section in which the position tag 20d is arranged (see the lower level of the figure).

The information processing system 2 includes a tag reader 100, a user terminal 300, and a management server 400 in addition to the position tags 20 and the item tags 40. The tag reader 100, the user terminal 300, and the management server 400 are connected to a network 5.

The management server 400 is an information processing apparatus that uses a database to manage position information indicating positions of the position tags 20 and the item tags 40 in a real space, which is similar to the management server 200 according to the first embodiment. An example of a specific configuration of the management server 400 will be described in the next section.

### 2-2. Configuration Example of Management Server

### 2-2-1. Basic Configuration

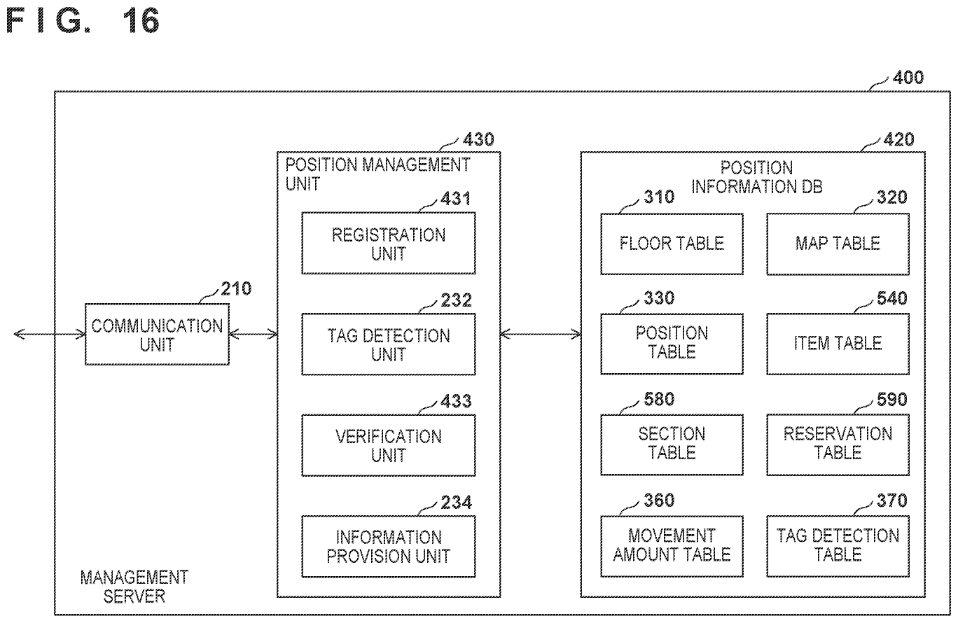

FIG. 16 is a block diagram illustrating an example of a configuration of the management server 400 according to the second embodiment. Referring to FIG. 16, the management server 400 includes a communication unit 210, a position information DB 420, and a position management unit 430.

The position information DB 420 includes a floor table 310, a map table 320, a position table 330, an item table 540, a section table 580, a reservation table 590, a movement amount table 360, and a tag detection table 370. The position management unit 430 is a set of a plurality of software modules that provide management functions for managing data within the position information DB 420, which is similar to the position management unit 230 according to the first embodiment. In the present embodiment, the position management unit 430 includes a registration unit 431, a tag detection unit 232, a verification unit 433, and an information provision unit 234.

### 2-2-2. Data Configuration Examples

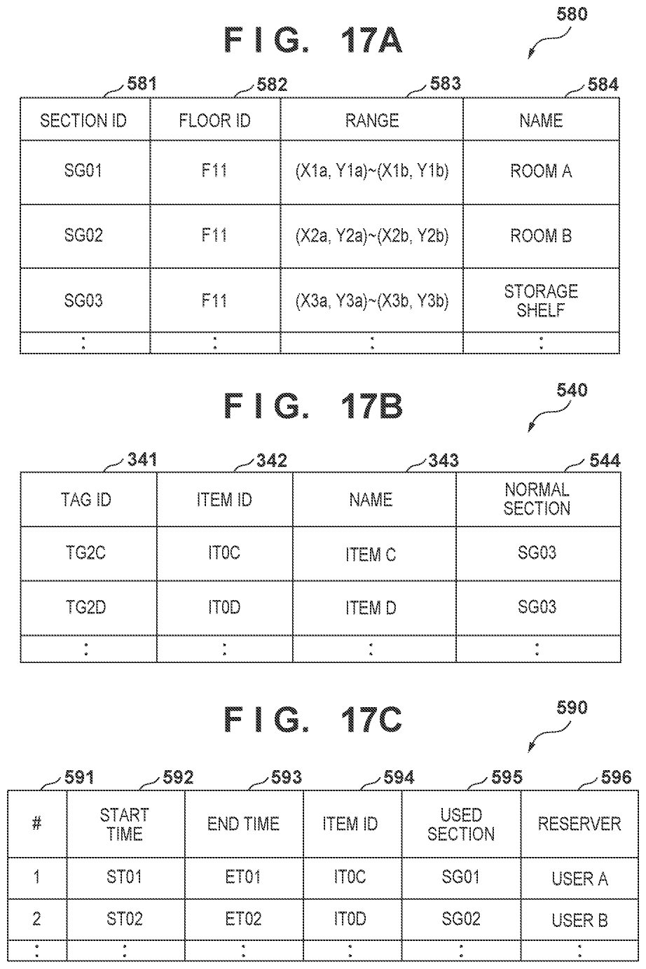

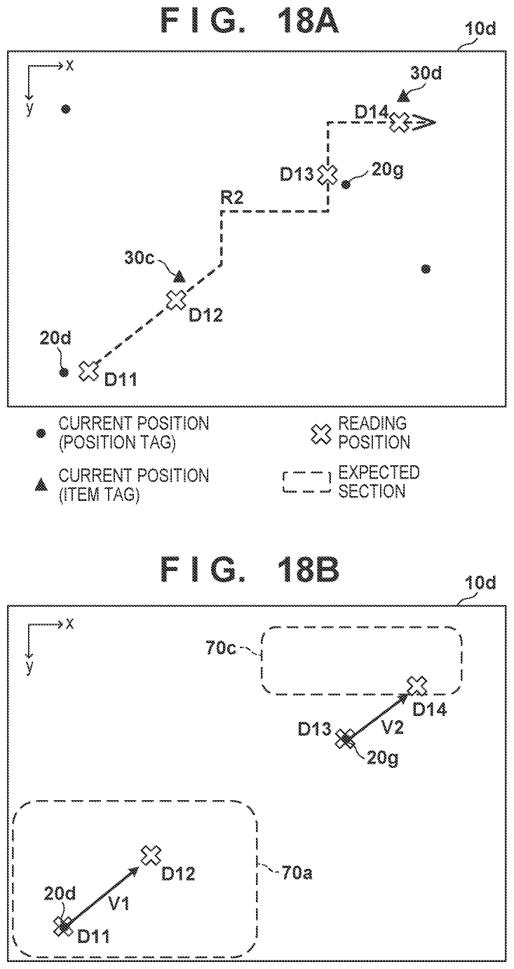

FIG. 17A to FIG. 17C respectively illustrate examples of configurations of the section table 580, the item table 540, and the reservation table 590 in the position information DB 420.

The section table 580 has four data elements of Section ID 581, Floor ID 582, Range 583, and Name 584. Section ID 581 is identification information that uniquely identifies each of the sections set on a floor 10. Using a value of Floor ID 311 of the floor table 310, Floor ID 582 indicates a floor 10 to which each section belongs. Range 583 indicates a spatial range occupied by each section on a floor 10 identified by Floor ID 582. As an example, on a two-dimensional plane of a floor 10, each section may have a shape of a quadrilateral, and Range 583 can be defined by the coordinates of one vertex of the quadrilateral and the coordinates of an opposite vertex thereof. As another example, each section may have a shape of a circle, and Range 583 can be defied by the coordinates of the center of the circle and a radius thereof. It should be noted that no limitation is intended by these examples, and each section may have any shape, such as a polygonal shape. Name 584 indicates a name of each section. In the example of FIG. 17A, the name of the section identified by Section ID “SG01” is “Room A”, the name of the section identified by Section ID “SG02” is “Room B”, and the name of the section identified by Section ID “SG03” is “Storage Shelf”.

The item table 540 has four data elements of Tag ID 341, Item ID 342, Name 343, and Normal Section 544. Using a value of Section ID 581 of the section table 580, Normal Section 544 indicates a section in which each of the items 30 to which the item tags 40 are attached (items 30 indicated by Item ID 342) is stored at normal times. In the example of FIG. 17B, an item identified by Item ID “IT0C” (e.g., the item 30c of FIG. 15) and an item identified by Item ID “IT0D” (e.g., the item 30d of FIG. 15) are both stored in the section identified by Section ID “SG03” at normal times.

The reservation table 590 illustrated in FIG. 17C is a table for storing expected positions for the items 30 to which the item tags 40 are attached in association with pieces of expected time information. The reservation table 590 has six data elements of Record Number 591, Start Time 592, End Time 593, Item ID 594, Used Section 595, and Reserver 596. Record Number 591 represents a number for uniquely identifying each record in the reservation table 590 (hereinafter referred to as a reservation record). Start Time 592 and End Time 593 are pieces of expected time information that respectively indicate the time at which the use of an item 30 is started and the time at which the use thereof is ended for each reservation record. Using a value of Item ID 342 of the item table 540, Item ID 594 indicates an item 30 to be used for each reservation record. Using a value of Section ID 581 of the section table 580, Used Section 595 indicates a section including the position at which an item 30 is used for each reservation record. Reserver 596 indicates a user who has reserved the use of an item 30 for each reservation record. In the example of FIG. 17C, reservation record #1 indicates that “User A” has registered an expected use of the item “IT0C” in the section “SG01” from time “ST01” to time “ET01”. Reservation record #2 indicates that “User B” has registered an expected use of the item “IT0D” in the section “SG02” from time “ST02” to time “ET02”.

### 2-2-3. Reservation of Use

The registration unit 431 of the position management unit 430 has a function of receiving a reservation of use of an item 30 from a user of the information processing system 2, in addition to the functions that have been described in relation to the registration unit 231 according to the first embodiment. The registration unit 431 may, for example, cause a display of the user terminal 300 to display a reservation reception screen, and receive an input of required information, such as a start time, an end time, an item, and a used section, on the reservation reception screen. The registration unit 431 registers the received information in the reservation table 590.

### 2-2-4. Verification of Positions of Items

In the present embodiment, the verification unit 433 assumes that wireless devices of a first type that are fixedly arranged in a real space, that is to say, the position tags 20 have been appropriately arranged at the device positions stored in the position information DB 220. Under this assumption, the verification unit 433 determines, based on comparison between a first positional relationship and a second positional relationship, whether the item tags 40, which are wireless devices of a second type that move together with the items 30, have been appropriately arranged at expected positions. During a time frame in which there is a reservation of use of an item 30 to which an item tag 40 is attached, the expected position of the item tag 40 may be a position inside a section indicated by Used Section 595 in the reservation table 590. During a time frame in which there is no reservation of use, the expected position of the item tag 40 may be a position inside a section indicated by Normal Section 544 in the item table 540. Similarly to the first embodiment, the first positional relationship represents a relative relationship among estimated positions indicated by Amount of Movement 374 in the tag detection table 370. The second positional relationship represents a relative relationship among expected positions of the item tags 40 relative to the registered positions of the position tags 20 indicated by Tag Position 333 in the position table 330. The verification unit 433 can determine that the first positional relationship matches the second positional relationship, for example, in a case where the estimated position of an item tag 40 that are subject to verification is included in an expected section under the assumption that the estimated positions of the position tags 20 coincide with the registered positions.

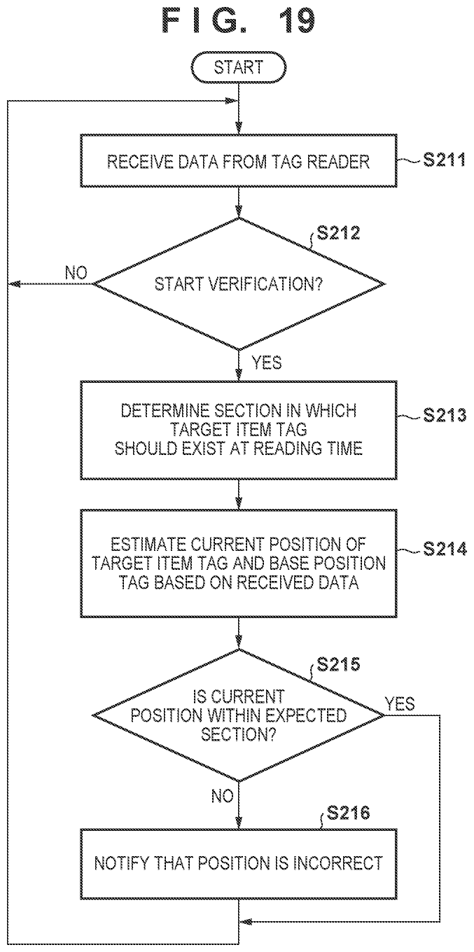

FIG. 18A and FIG. 18B are explanatory diagrams for explaining comparison between the two positional relationships in the present embodiment. In the figures, circles denote the current positions of the respective position tags and triangles denote the current positions of the respective item tags 40. In the example of FIG. 18A, a plurality of position tags 20 including the position tags 20d and 20g are arranged on a floor 10d. Furthermore, the items 30c and exist on the floor 10d. At a certain time, the user moves along, for example, a dash-line arrow R2 while carrying the tag reader 100 on the floor 10d. Then, the tag reader 100 reads a tag ID of the position tag 20d at a reading position D11, a tag ID of the item tag 40c of the item 30c at a reading position D12, a tag ID of the position tag 20g at a reading position D13, and a tag ID of the item tag 40d of the item 30d at a reading position D14. Based on measurement result data and reading result data received from the tag reader 100, the tag detection unit 232 of the management server 400 stores the four tag IDs that have been read, times of reading, a reader ID, and amounts of relative movement from a reference position to the tag detection table 370.

It is assumed here that the time of reading of the tag ID from the item tag of the item 30c belongs to a time frame between the start time and the end time of the reservation of use indicated by record #1 in the reservation table 590 of FIG. 17C. This reservation record, therefore, indicates that the item 30c is expected to be used in the section “SG01” (i.e., “Room A”) at the above-described time of reading. The verification unit 433 derives a vector V1 indicating a relative position of the item 30c (item tag 40c) relative to the position tag 20d (the first positional relationship) by, for example, subtracting the amount of relative movement of the reading position D11 from the amount of relative movement of the reading position D12. In a case where the registered position of the position tag 20a is an initial point of the vector V1, a terminal point of the vector V1 is supposed to be inside the section “SG01” indicated by a dash line 70a in FIG. 18B (the second positional relationship), according to the above-described reservation record. The verification unit 433 compares these positional relationships; as the terminal point of the vector V1 is inside the dash line 70a in the example of FIG. 18B, it is determined that the item 30c exists appropriately at an expected position at the above-described time of reading.

Furthermore, it is assumed that the time of reading of the tag ID from the item tag 40d of the item 30d does not belong to any of the time frames indicated by the records of the reservation table 590. Therefore, the item 30d is expected to be stored in the section “SG03” indicated by Normal Section 544 in the item table 540 (i.e., “Storage Shelf”) at the above-described time of reading. The verification unit 433 derives a vector V2 indicating a relative position of the item 30d (item tag 40d) relative to the position tag 20g (the first positional relationship) by, for example, subtracting the amount of relative movement of the reading position D13 from the amount of relative movement of the reading position D14. In a case where the registered position of the position tag 20g is an initial point of the vector V2, a terminal point of the vector V2 is supposed to be inside the section “SG03” indicated by a dash line 70c in FIG. 18B (the second positional relationship). The verification unit 433 compares these positional relationships; as the terminal point of the vector V2 is inside the dash line 70c in the example of FIG. 18B, it is determined that the item 30d exists appropriately at an expected position at the above-described time of reading.

It should be noted that in making the above-described determination about whether an item 30 that is subject to verification is inside an expected section, the tolerance d1 for misalignment described in the first embodiment may be taken into consideration. That is to say, even in a case where the item 30 is positioned outside the expected section, the verification unit 433 may determine that the item 30 appropriately exists at an expected position when a distance between an estimated position of the item 30 and a boundary of the expected section falls below the tolerance d1.

As illustrated in FIG. 18B, a position tag 20 that is used as a base in deriving a relative position of an item 30 subject to verification may be a position tag 20 that has been detected at the nearest location to the item 30 subject to verification among position tags 20 whose tag IDs have been read by the tag reader 100. By using a reading position of the nearest position tag 20 as the reference position, an error of relative positions can be suppressed, and the accuracy of verification can be increased.

In a case where it has been determined that the first positional relationship does not match the second positional relationship and the item 30 does not exist at its expected position, the verification unit 433 notifies the user of the incorrectness of the position of the item 30 on, for example, a screen of the user terminal 300. Upon receiving this notification, the user can take a necessary action, such as returning of the item 30 that has been forgotten to be returned after use to a normal section, for example. It should be noted that, in a case where the first positional relationship does not match the second positional relationship, the verification unit 433 may automatically correct the registered positions of items 30 in the database (e.g., the position coordinates of normal sections), as in the second alteration example of the first embodiment.

### 2-3. Flow of Process

In the present section, an example of a flow of a process inside the information processing system 2 according to the present embodiment will be described using a flowchart of FIG. 19.

### 2-3-1. Position Verification Process

FIG. 19 is a flowchart illustrating an example of a flow of a position verification process that can be executed by the tag detection unit 232 and the verification unit 433 of the position management unit 430 according to the present embodiment.

In S211, the tag detection unit 232 waits for reception of data from the tag reader 100. When measurement result data has been received from the tag reader 100, the tag detection unit 232 stores one or more records of the measurement result data to the movement amount table 360. Furthermore, when reading result data has been received from the tag reader 100, the tag detection unit 232 stores one or more records of the reading result data to the tag detection table 370, and add values of Amount of Movement 374 in the respective records obtained from the movement amount table 360.

In S212, the verification unit 433 monitors the tag detection table 370, and determines whether to start verification of arrangements of items 30. For example, the verification unit 433 may determine that verification of arrangements of the items 30 to which the item tags 40 are attached is to be started in a case where the results of tag reading from the position tags 20 and the item tags 40 associated with the same floor 10 have been stored to the tag detection table 370. In a case where the verification unit 433 has determined that the verification of arrangements is to be started, the process proceeds to S213. In a case where the verification of arrangements is not to be started, the process returns to S211, and the reception of data from the tag reader 100 and the accumulation of data in the position information DB 420 are repeated.

In S213, the verification unit 433 determines a section in which a target item tag 40 should exist at the time of reading with reference to the item table 540 and the reservation table 590. Next, in S214, based on data received from the tag reader 100, the verification unit 433 estimates the current positions of the target item tag 40 and a position tag 20 used as a base. Next, in S215, the verification unit 433 determines whether the current position estimated for the target item tag 40 is inside the section (expected section) determined in S213 when the current positions of the position tags 20 have been brought to coincide with the registered positions. Here, in a case where it has been determined that the current position of the target item tag 40 is not inside the expected section, the verification unit 433 notifies, in S216, the user that the item 30 to which the target item tag 40 is attached does not exist at a position where it is supposed to exist. In a case where it has been determined that the current position of the target item tag 40 is inside the expected section, the process returns to S211, the reception of data from the tag reader 100 and the accumulation of data in the position information DB 420 are repeated, and verification of arrangements of items 30 is performed again as necessary.

### 2-3-2. Alternation Example

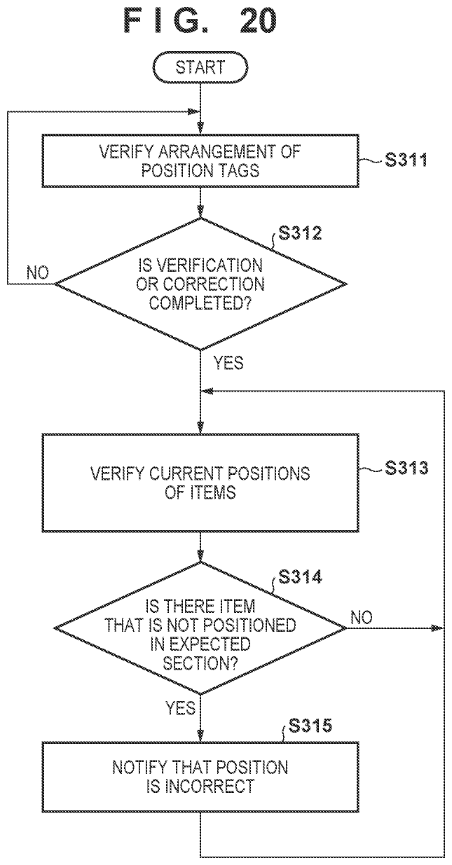

In an alteration example, the information processing system 2 may perform both of the verification of arrangements of position tags 20 described in the first embodiment, and the verification of arrangements of item tags 40 described in the second embodiment. Typically, the verification of arrangements of position tags 20 is performed at the time of initial adoption of the system, whereas tracking and verification of the positions of item tags 40 are started after the verification has succeeded with respect to a sufficient number of position tags 20. FIG. 20 is a flowchart illustrating an example of a flow of a schematic process according to such an alteration example.

First, in S311, the verification unit 433 verifies arrangements of a plurality of position tags 20 for which the statuses are “Unverified” by comparing the first positional relationship estimated based on data received from the tag reader 100 with the second positional relationship based on registered information of a database. This verification is repeated until it has been determined in S312 that the verification has been completed, or correction of arrangements or correction of the registered information has been completed.

Upon reaching a state where the actual arrangements of the position tags 20 sufficiently match the registered information of the database, tracking and verification of positions of item tags 40 are started in S313. In S313, the verification unit 433 verifies whether the current positions of the items 30 to which the item tags 40 are attached are appropriate by comparing the first positional relationship between a position tag 20 used as a base and the item tags whose tag IDs have been read with the second positional relationship based on the registered information of the database. In a case where the verification unit 433 has determined that there is an item 30 that is not positioned in an expected section in 5314 in accordance with the verification result, the user is notified of the incorrectness of the position of the item 30 in S315. In a case where every detected item 30 is appropriately positioned inside an expected section, the user need not be notified, and tracking and verification of the positions of item tags 40 are repeated.

### 2-4. Summary of Second Embodiment

According to the second embodiment, a determination is made for RFID tags that have been fixedly arranged in a real space and RFID tags that move together with items about whether the first positional relationship among estimated positions of these tags matches the second positional relationship among corresponding registered positions in a DB. Therefore, using the RFID tags that have been fixedly arranged as a base, whether items exist at appropriate positions (e.g., whether items have been used at appropriate locations or stored at correct locations) can easily be detected. In the second embodiment as well, verification of arrangements of items does not depend on electric waves from a satellite, thereby allowing the verification to function effectively in a space like the inside of a building or underground. Furthermore, as there is no need to implement a GPS function in a tag reader that reads tag IDs from the RFID tags, the cost of adoption of the tag reader, as well as the size of the tag reader, can be easily reduced.

In addition, according to the second embodiment, expected positions of RFID tags that move together with items are stored in a DB in association with pieces of expected time information, and whether the items are at the expected positions at times indicated by these pieces of expected time information is determined based on comparison between the first and second positional relationships. Therefore, even if items are used at various locations in a real space and are not fixed in position, whether the items exist at appropriate positions at respective time points can easily be determined.

The present invention makes it possible to detect a misalignment between a position indicated by registration information in a system and an actual arrangement of a device in a real space.

### 3. Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing system comprising:
a plurality of wireless devices arranged in a real space;
a reading apparatus that includes a reading unit configured to read identification information stored in each wireless device and a measuring unit configured to measure a relative amount of movement in the real space; and
a management unit configured to manage a database in which a position in the real space at which each wireless device should be arranged is registered in association with identification information of the wireless device,
wherein the reading apparatus is configured to provide the management unit with the identification information read by the reading unit and movement amount information indicating the amount of movement measured by the measuring unit at the time of the reading, and
the management unit is configured to determine, for two or more wireless devices arranged in the real space, whether a first positional relationship among the two or more wireless devices estimated based on the identification information and the movement amount information matches a second positional relationship among corresponding registered positions stored in the database.

2. The information processing system according to claim 1, wherein the management unit is configured to,
in a case where it is determined that the first positional relationship does not match the second positional relationship, present a result of the determination to a user, and
cause the user to perform one or more of:
correction of arrangement of a wireless device in the real space;
designation of a wireless device that has been arranged at a corresponding registered position; and
designation of a wireless device of which corresponding registered position should be corrected in the database.

3. The information processing system according to claim 2, wherein the management unit is configured to, after presenting the result of determination that the first positional relationship does not match the second positional relationship to the user and in a case where a wireless device that has been arranged at a corresponding registered position is designated by the user, further determine, based on comparison between the first positional relationship and the second positional relationship, which wireless device has been incorrectly arranged other than the designated wireless device from among the two or more wireless devices.

4. The information processing system according to claim 2, wherein the management unit is configured to, after presenting the result of determination that the first positional relationship does not match the second positional relationship to the user and in a case where a wireless device of which corresponding registered position should be corrected in the database is designated by the user, correct a registered position corresponding to the designated wireless device to a position estimated based on the first positional relationship.

5. The information processing system according to claim 1, wherein the management unit is configured to, in a case where it is determined that the first positional relationship does not match the second positional relationship, correct the corresponding registered position stored in the database such that it matches the first positional relationship.

6. The information processing system according to claim 1, wherein the two or more wireless devices includes:
a first type of wireless device arranged in the real space in a fixed manner; and
a second type of wireless device that is attached to an item and moves together with the item;
wherein the management unit is configured to determine, based on comparison between the first positional relationship and the second positional relationship, whether the second type of wireless device has been arranged at a corresponding registered position assuming that the first type of wireless device has been arranged at a corresponding registered position stored in the database.

7. The information processing system according to claim 6, wherein an expected position for the second type of wireless device is further registered in the database in association with expected time information, and
the management unit is configured to determine, based on comparison between the first positional relationship and the second positional relationship, whether the second type of wireless device has been arranged at the expected position at a time indicated by the expected time information.

8. The information processing system according to claim 1, wherein the management unit is configured to determine that the first positional relationship matches the second positional relationship in a case where a misalignment of a position in the first positional relationship with respect to a corresponding registered position in the second positional relationship falls below a tolerance for any wireless device from among the two or more wireless devices.

9. The information processing system according to claim 1, wherein the database is configured to store a registered position of each wireless device in association with one of a plurality of places within the real space, and
the management unit is configured to determine whether the first positional relationship matches the second positional relationship for the two or more wireless devices associated with the same place.

10. The information processing system according to claim 1, wherein the database is configured to further store map information representing maps of places that are associated with the two or more wireless devices, and
the management unit is configured to, in a case where it is determined that the first positional relationship does not match the second positional relationship, cause a screen of a user terminal to display, based on the map information, a map of the place on which a position of at least one of the two or more wireless devices is mapped.

11. The information processing system according to claim 1, wherein the wireless device is a radio frequency identification (RFID) tag, and
the reading unit of the reading apparatus is configured to emit an electromagnetic wave to a reading range and read the identification information sent back from the RFID tag utilizing energy of the electromagnetic wave.

12. The information processing system according to claim 1, wherein the measuring unit is configured to measure the relative amount of movement based on sensor data output from a three-axis acceleration sensor, a gyro sensor, and a geomagnetic sensor.

13. The information processing system according to claim 1, wherein the information processing system comprises:
a server apparatus arranged in a cloud environment and including the management unit,
wherein the reading apparatus is configured to transmit the identification information and the movement amount information to the server apparatus directly or indirectly via another apparatus.

14. An information processing apparatus that manages a database in which a position in a real space at which each of a plurality of wireless devices should be arranged is registered in association with identification information of the wireless device, comprising:
a communication unit configured to receive, from a reading apparatus that is capable of reading identification information stored in each wireless device and is capable of measuring relative amount of movement in the real space, the read identification information and movement amount information indicating the amount of movement measured at the time of the reading; and
a determination unit configured to determine, for two or more wireless devices arranged in the real space, whether a first positional relationship among the two or more wireless devices estimated based on the identification information and the movement amount information matches a second positional relationship among corresponding registered positions stored in the database.
